(19) United States
(12) Patent Application Publication
(10) Pub. No.: US 2017/0134074 A1
(43) Pub. Date: May 11, 2017

(54) CANCELLATION SIGNAL GENERATION FOR MULTIPLE INPUT AND MULTIPLE OUTPUT (MIMO) ANALOG INTERFERENCE CANCELLATION

(71) Applicant: QUALCOMM Incorporated, San Diego, CA (US)

(72) Inventors: Ozgur Dural, Sunnyvale, CA (US); Insoo Hwang, San Diego, CA (US); Won-ick Lee, San Diego, CA (US); Samir Soliman, Poway, CA (US); Mark Maggenti, Del Mar, CA (US); Kaushik Chakraborty, San Diego, CA (US); Sundar Rajan Krishnamurthy, San Diego, CA (US)

(21) Appl. No.: 15/291,839

(22) Filed: Oct. 12, 2016

Related U.S. Application Data
(60) Provisional application No. 62/254,061, filed on Nov. 11, 2015.

(51) Int. Cl. H04B 7/04; H04B 7/08

(52) U.S. Cl. CPC H04B 7/0413; H04B 7/0805

(57) ABSTRACT

A multiple input and multiple output device includes a first input switch, a second input switch, a first set of analog interference cancellation (AIC) circuits, and a second set of AIC circuits. The first input switch is configured to select one of a first transmit input of first transmit inputs or a first transmit input of second transmit inputs. The second input switch is configured to select one of a second transmit input of the first transmit inputs or a second transmit input of the second transmit inputs. The first set of AIC circuits and the second set of AIC circuits are coupled to the first input switch and to the second input switch. The first set of AIC circuits is configured to output a first cancellation signal. The second set of AIC circuits is configured to output a second cancellation signal.

### I. CROSS-REFERENCE TO RELATED APPLICATIONS

The present application claims priority from U.S. Provisional Patent Application No. 62/254,061, filed Nov. 11, 2015, entitled “CANCELLATION SIGNAL GENERATION,” which is incorporated by reference herein in its entirety.

### II. FIELD

The present disclosure is generally related to cancellation signal generation for analog interference cancellation, more specifically for multiple antenna systems.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

A computing device may have multiple antennas to receive and transmit wireless signals. One or more transmitting antennas of the device may generate signals that cause interference with signals received by one or more receiving antennas of the device. For example, a transmitting antenna may be transmitting at approximately the same frequency and at the same time as a receiving antenna is receiving. To illustrate, same-band interference may occur between Bluetooth (wireless personal area network (WPAN)) and 2.4 gigahertz (GHz) wireless fidelity (WiFi) (wireless local area network (WLAN)); adjacent band interference may occur between WLAN and Long Term Evolution (LTE) band 7, 40, 41; harmonic interference may occur between 5.7 GHz industrial, scientific, and medical (ISM) and 1.9 GHz Personal Communications Service (PCS); and an intermodulation issue may occur between 7xx megahertz (MHz) and a global positioning system (GPS) receiver.

### IV. SUMMARY

In a particular aspect, a multiple input and multiple output device includes a first input switch, a second input switch, a first set of analog interference cancellation (AIC) circuits, and a second set of AIC circuits. The first input switch is configured to select one of a first transmit input of a first set of transmit inputs or a first transmit input of a second set of transmit inputs. The second input switch is configured to select one of a second transmit input of the first set of transmit inputs or a second transmit input of the second set of transmit inputs. The first set of AIC circuits is coupled to the first input switch and to the second input switch. The first set of AIC circuits is configured to output components of a first cancellation signal. The second set of AIC circuits is coupled to the first input switch and to the second input switch. The second set of AIC circuits is configured to output components of a second cancellation signal.

In another particular aspect, a method includes selecting, at a first input switch, one of a first transmit input of a first set of transmit inputs or a first transmit input of a second set of transmit inputs. The method also includes selecting, at a second input switch, one of a second transmit input of the first set of transmit inputs or a second transmit input of the second set of transmit inputs. The method further includes generating, at a first set of analog interference cancellation (AIC) circuits, components of a first cancellation signal based at least in part on a first input signal received from the first input switch. The method also includes generating, at a second set of AIC circuits, components of a second cancellation signal based at least in part on a second input signal received from the second input switch.

In another particular aspect, a computer-readable storage device stores instructions that, when executed by a processor, cause the processor to perform operations including operating a first input switch to select one of a first transmit input of a first set of transmit inputs or a first transmit input of a second set of transmit inputs. The operations also include operating a second input switch to select one of a second transmit input of the first set of transmit inputs or a second transmit input of the second set of transmit inputs. The operations further include operating a first set of analog interference cancellation (AIC) circuits to output components of a first cancellation signal to a first cancellation input. The first set of AIC circuits is coupled to the first input switch and to the second input switch. The operations also include operating a second set of AIC circuits to output components of a second cancellation signal to a second cancellation input. The second set of AIC circuits is coupled to the first input switch and to the second input switch.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative example of a system operable to generate a cancellation signal;

FIG. 2 is a diagram of another illustrative example of a system operable to generate a cancellation signal;

FIG. 3 is a diagram of another illustrative example of a system operable to generate a cancellation signal;

FIG. 4 is a diagram of another illustrative example of a system operable to generate a cancellation signal;

FIG. 5 is a diagram of another illustrative example of a system operable to generate a cancellation signal;

FIG. 6 is a diagram of another illustrative example of a system operable to generate a cancellation signal;

FIG. 7 is a diagram of another illustrative example of a system operable to generate a cancellation signal;

FIG. 8 is a flow diagram of a method of operation at a device of one or more systems disclosed herein;

FIG. 9 is a diagram of a correlation matrix;

FIG. 10 is a diagram of another illustrative example of a system operable to generate a cancellation signal;

FIG. 11 is a diagram of an illustrative example of an antenna configuration of one or more systems disclosed herein;

FIG. 12 is a diagram of additional illustrative examples of antenna configuration of one or more systems disclosed herein;

FIG. 13 is a flow diagram of a method of operation at a device of one or more systems disclosed herein; and

FIG. 14 is a diagram of a wireless device that is operable to support various aspects of one or more methods, systems, apparatuses, and computer-readable media disclosed herein.

### VI. DETAILED DESCRIPTION

Systems and methods of cancellation signal generation are disclosed. A device may include a plurality of antennas that are arranged in a multiple-in multiple-out (MIMO) configuration. The plurality of antennas may include a first set of antennas and a second set of antennas. The first set of antennas may be configured to transmit when the second set of antennas is receiving and to receive when the second set of antennas is transmitting. The device may include analog interference cancellation capabilities. For example, the device may include an analog interference cancellation (AIC) circuit configured to generate a cancellation signal based on a reference signal (e.g., an input signal) received from a first antenna (e.g., a transmit (TX) antenna) of the first set of antennas and a feedback signal received from a first antenna (e.g., a receive (RX) antenna) of the second set of antennas. The AIC circuit may be configured to provide the cancellation signal to a RX output of the RX antenna to reduce (e.g., cancel) interference of the input signal on a signal received by the RX antenna.

The device may include AIC circuitry coupled to input switching circuitry, to feedback switches, and to output switching circuitry. The device may, in a first mode, operate the input switching circuitry to select the first set of antennas and may operate the feedback switches and the output switching circuitry to select the second set of antennas. The device may, in a second mode, operate the input switching circuitry to select the second set of antennas and may operate the feedback switches and the output switching circuitry to select the first set of antennas. The input switching circuitry, the feedback switches, and the output switching circuitry may enable the device to reuse AIC circuits of the AIC circuitry to generate cancellation signals as compared to having a dedicated AIC circuit corresponding to each of the first set of antennas and the second set of antennas as TX antennas and each of the first set of antennas and the second set of antennas as RX antennas. Reusing the AIC circuits may enable the device to reduce an amount of hardware to provide interference cancellation.

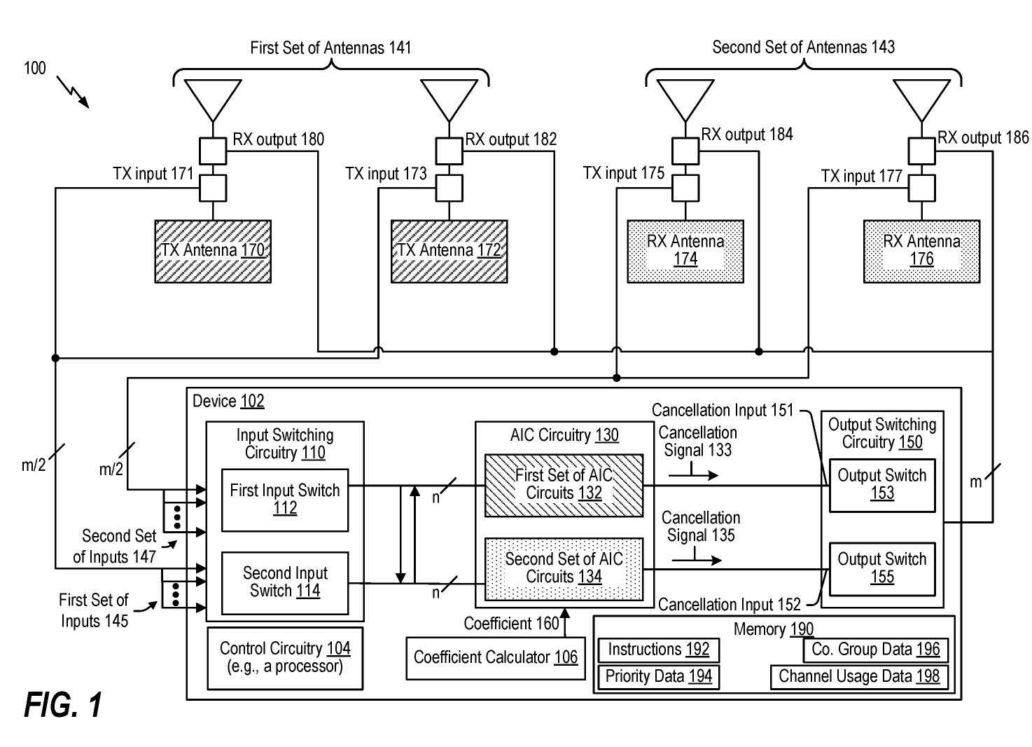

Referring to FIG. 1, a particular illustrative example of a system is shown and generally designated 100. The system 100 includes a device 102. The device 102 may be coupled to a plurality of antennas (e.g., m antennas). The plurality of antennas may include a first set of antennas 141 (e.g., a transmit (TX) antenna 170, a TX antenna 172, or both) and a second set of antennas 143 (e.g., a receive (RX) antenna 174, a RX antenna 176, or both). In some implementations, the plurality of antennas may include fewer than or more than four antennas. For example, the first set of antennas 141 may include fewer than two antennas or more than two antennas. The second set of antennas 143 may include fewer than two antennas or more than two antennas.

Each antenna of the first set of antennas 141, the second set of antennas 143, or both, may include a TX input, a RX output, or both. For example, the TX antenna 170 may include a TX input 171, a RX output 180, or both. The TX antenna 172 may include a TX input 173, a RX output 182, or both. The RX antenna 174 may include a RX output 184, a TX input 175, or both. The RX antenna 176 may include a RX output 186, a TX input 177, or both. An antenna (e.g., the TX antenna 170, the TX antenna 172, the RX antenna 174, or the RX antenna 176) may be configured to provide a transmission signal via a corresponding TX input to the device 102, to receive a cancellation signal via a corresponding RX output from the device 102, or both. For example, the TX antenna 170 may be configured to provide a transmission signal (e.g., an input signal) via the TX input 171 to the device 102, to receive a cancellation signal via the RX output 180 from the device 102, or both.

The plurality of antennas may be arranged in a multiple-in multiple-out (MIMO) configuration. For example, the first set of antennas 141 may be configured to transmit when the second set of antennas 143 is receiving and may be configured to receive when the second set of antennas 143 is transmitting. For example, at a first time, the first set of antennas 141 may transmit and the second set of antennas 143 may receive. To illustrate, the TX input 171, the TX input 173, the RX output 184, the RX output 186, or a combination thereof, may be activated at the first time. At a second time, the first set of antennas 141 may receive and the second set of antennas 143 may transmit. For example, the RX output 180, the RX output 182, the TX input 175, the TX input 177, or a combination thereof, may be activated at the second time.

The device 102 may include input switching circuitry 110 that is configured to couple to the TX input 171, the TX input 173, the TX input 175, the TX input 177, or a combination thereof. For example, the first input switch 112 may be configured to select one of a first set of inputs 145, such as the TX input 171, or one of a second set of inputs 147, such as the TX input 175. The second input switch 114 may be configured to select one of the first set of inputs 145, such as the TX input 173, or one of the second set of inputs 147, such as the TX input 177. The device 102 may include output switching circuitry 150 that is configured to couple to the RX output 180, the RX output 182, the RX output 184, the RX output 186, or a combination thereof. The input switching circuitry 110 may be coupled, via analog interference cancellation (AIC) circuitry 130, to the output switching circuitry 150.

The input switching circuitry 110 may include a plurality of input switches (e.g., a first input switch 112, a second input switch 114, or both). The AIC circuitry 130 may include a plurality of AIC circuits (e.g., a first set of AIC circuits 132, a second set of AIC circuits 134, or both). The output switching circuitry 150 may include a plurality of output switches (e.g., an output switch 153, an output switch 155, or both).

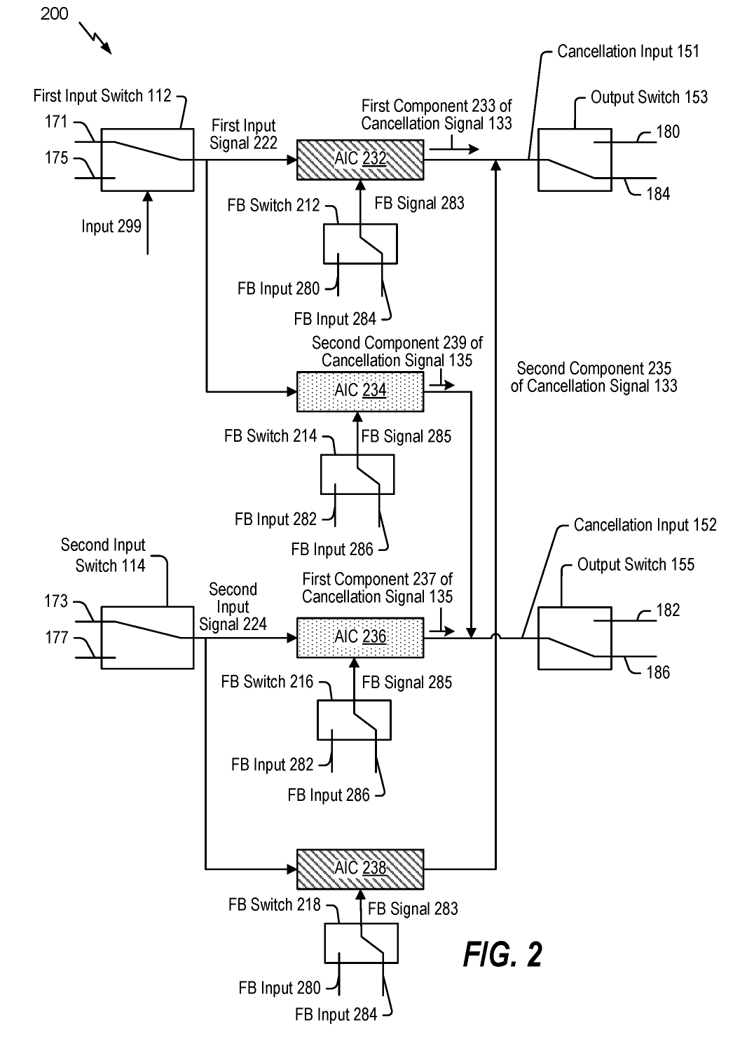

The input switching circuitry 110 may be configured to select TX inputs of one of the first set of antennas 141 or the second set of antennas 143, as further described with reference to FIG. 2. The device 102 may be configured to perform analog interference cancellation. For example, the AIC circuitry 130 may be configured to generate a plurality of cancellation signals (e.g., “n” cancellation signals, where n is a positive integer) based on input signals received from the selected TX inputs. To illustrate, the first set of AIC circuits 132 may generate a cancellation signal 133, the second set of AIC circuits 134 may generate the cancellation signal 135, or both, as further described with reference to FIG. 2. The output switching circuitry 150 may be configured to select RX outputs of the other of the first set of antennas 141 or the second set of antennas 143, as further described with reference to FIG. 2. The output switching circuitry 150 may be configured to output the cancellation signals to the selected RX outputs. For example, the output switch 153 may receive the cancellation signal 133, via a cancellation input 151, from the first set of AIC circuits 132, the output switch 155 may receive the cancellation signal 135, via a cancellation input 152, from the second set of AIC circuits 134, or both. The output switching circuitry 150 may provide the cancellation signal 133 to an RX output of the selected RX outputs, as further described with reference to FIG. 2.

The AIC circuitry 130 may be coupled to a coefficient calculator 106. In a particular implementation, the AIC circuitry 130 may include the coefficient calculator 106. The AIC circuitry 130 may be configured to generate the cancellation signals based on a coefficient 160 received from the coefficient calculator 106. The device 102 may include control circuitry 104. The control circuitry 104 may be configured to initiate operations of the input switching circuitry 110, the AIC circuitry 130, the output switching circuitry 150, or a combination thereof, such as via one or more control signals.

The device 102 may include a memory 190. The memory 190 may correspond to a computer-readable storage device. The memory 190 may be configured to store one or more instructions 192. The control circuitry 104, the input switching circuitry 110, the AIC circuitry 130, the output switching circuitry 150, or a combination thereof, may include a processor configured to execute the one or more instructions 192 to perform operations described herein. Alternatively, or in addition, the control circuitry 104, the input switching circuitry 110, the AIC circuitry 130, the output switching circuitry 150, or a combination thereof, may include hardware (e.g., one or more circuits) configured to perform operations described herein.

The memory 190 may be configured to store priority data 194. The priority data 194 may indicate relative priority of two or more channels. For example, the first input switch 112 may be associated with a transmission on a first channel. The second input switch 114 may be associated with a transmission on a second channel. The cancellation signal 133 may be associated with a signal reception on a third channel. The cancellation signal 135 may be associated with a signal reception on a fourth channel. The priority data 194 may indicate relative priority of two or more of the first channel, the second channel, the third channel, or the fourth channel. In some implementations, the control circuitry 104 may selectively deactivate at least one AIC circuit. For example, the control circuitry 104 may deactivate the second set of AIC circuits 134 in response to determining that the priority data 194 indicates that the fourth channel has a lowest relative priority.

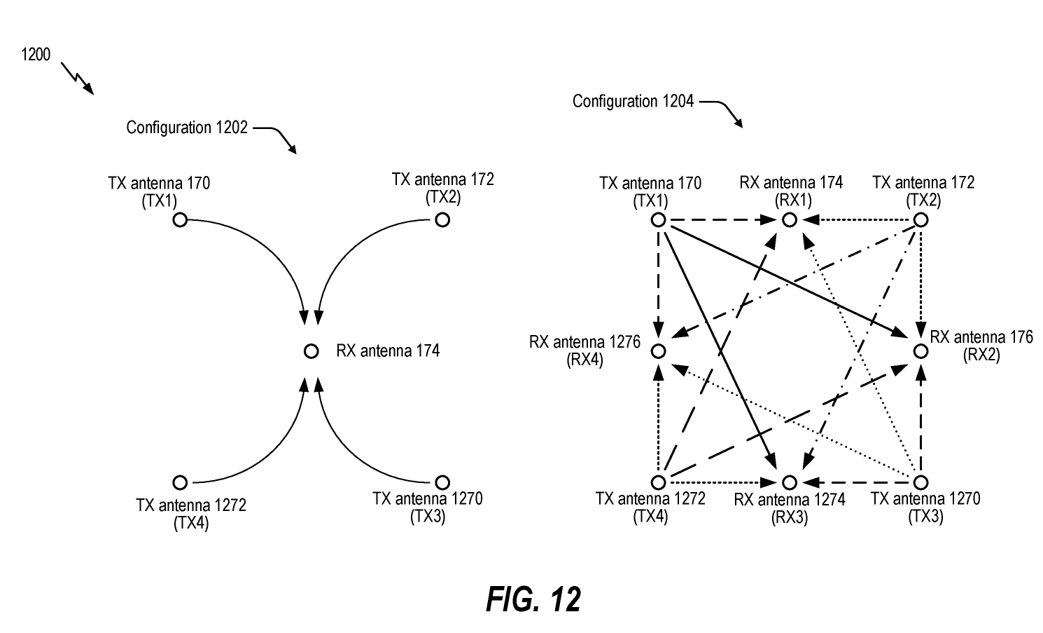

The memory 190 may be configured to store coefficient group data 196. The coefficient group data 196 may indicate coefficient groups of pairs of TX antennas and RX antennas. For example, the coefficient group data 196 may indicate that a first coefficient group includes a first pair having the TX antenna 170 and the RX antenna 174 and a second pair having the TX antenna 170 and the RX antenna 176. As another example, the coefficient group data 196 may indicate that the first coefficient group includes a first pair having the TX antenna 170 and the RX antenna 174 and a second pair having the TX antenna 172 and the RX antenna 176. The control circuitry 104 may selectively deactivate a portion of at least one AIC circuit based on the coefficient group data 196, such as further described with reference to FIG. 12.

The memory 190 may be configured to store channel usage data 198. The channel usage data 198 may indicate channel configurations that correspond to a number (e.g., 90%) of cases. The channel usage data 198 may indicate a number of activated AIC circuits corresponding to each of the channel configurations. For example, the number of activated AIC circuits may take advantage of symmetries of the corresponding channel configuration. The control circuitry 104 may determine a channel configuration associated with an antenna (e.g., the TX antenna 170) coupled to the first input switch 112 and an antenna (e.g., the RX antenna 174) coupled to the cancellation input 151. The control circuitry 104 may determine whether the channel usage data 198 includes the channel configuration. The control circuitry 104 may, in response to determining that the channel usage data 198 include the channel configuration, deactivate at least one AIC circuit of the AIC circuitry 130 based on the channel usage data 198. For example, the channel usage data 198 may indicate a first number of activated AIC circuits corresponding to the channel configuration. The AIC circuitry 130 may include a second number of activated AIC circuits. The control circuitry 104 may, in response to determining that the second number is greater than the first number, deactivate at least one AIC circuit of the AIC circuitry 130.

Alternatively, the control circuitry 104 may, in response to determining that the channel usage data 198 does not include the channel configuration, deactivate at least one AIC circuit of the AIC circuitry 130 based on a feedback signal corresponding to the RX antenna 174.

The system 100 may enable the input switching circuitry 110 to select one of the first set of antennas 141 or the second set of antennas 143 and the output switching circuitry 150 to select the other of the first set of antennas 141 or the second set of antennas 143. A size of the AIC circuitry 130 may thus be reduced. For example, the same group of AIC circuits may be used to generate cancellation signals when the first set of antennas 141 is transmitting as when the second set of antennas 143 is transmitting by having the input switching circuitry 110 switch from TX inputs of the first set of antennas 141 to TX inputs of the second set of antennas 143 and having the output switching circuitry 150 switch from RX outputs of the second set of antennas 143 to RX outputs of the first set of antennas 141. The cancellation signals may reduce interference between the receiving antennas and the transmitting antennas.

Referring to FIG. 2, a particular illustrative example of a system is shown and generally designated 200. The system 200 may correspond to the system 100 of FIG. 1. For example, one or more components of the system 200 may be included in the system 100.

The system 200 may include a plurality of input switches of the input switching circuitry 110 of FIG. 1. For example, the system 200 may include the first input switch 112, the second input switch 114, or both. Each of the plurality of input switches (e.g., the first input switch 112, the second input switch 114, or both) may be coupled, via a plurality of AIC circuits of the AIC circuitry 130 of FIG. 1, to a plurality of output switches of the output switching circuitry 150 of FIG. 1. For example, the first input switch 112 may be coupled, via an AIC circuit 232, to the cancellation input 151 of the output switch 153. The first input switch 112 may also be coupled, via an AIC circuit 234, to the cancellation input 152 of the output switch 155. The second input switch 114 may be coupled, via an AIC circuit 236, to the cancellation input 152 of the output switch 155. The second input switch 114 may also be coupled, via an AIC circuit 238, to the cancellation input 151 of the output switch 153.

A count of output switches may correspond to a size of the second set of antennas 143 of FIG. 1. In some implementations, the second set of antennas 143 may include more than two antennas. For example, the second set of antennas 143 may include three antennas and the output switching circuitry 150 may include a third output switch. In this example, the first input switch 112 may be coupled, via a first additional AIC, to a cancellation input of the third output switch and the second input switch 114 may be coupled, via a second additional AIC, to the cancellation input of the third output switch.

The AIC circuitry 130 of FIG. 1 may include the AIC circuit 232, the AIC circuit 234, the AIC circuit 236, the AIC circuit 238, or a combination thereof. For example, the first set of AIC circuits 132 may include the AIC circuit 232, the AIC circuit 238, or both. Each of the first set of AIC circuits 132 may be coupled to the cancellation input 151. The second set of AIC circuits 134 may include the AIC circuit 234, the AIC circuit 236, or both. Each of the second set of AIC circuits 134 may be coupled to the cancellation input 152.

Each of the AIC circuits 232-238 may be configured to receive a feedback signal via a feedback (FB) switch, as described herein. The AIC circuit 232 may be coupled to a FB switch 212, the AIC circuit 234 may be coupled to a FB switch 214, the AIC circuit 236 may be coupled to a FB switch 216, the AIC circuit 238 may be coupled to a FB switch 218, or a combination thereof. In some implementations, the FB switch 212 may correspond to the FB switch 218. For example, each of the first set of AIC circuits 132 may be coupled to the same FB switch (e.g., the FB switch 212). In some implementations, the FB switch 214 may correspond to the FB switch 216. For example, each of the second set of AIC circuits 134 may be coupled to the same FB switch (e.g., the FB switch 214).

During operation, the input switches 112-114 may each select a TX input of one of the first set of antennas 141 of FIG. 1 or the second set of antennas 143 of FIG. 1. The FB switches 212-218 may each select an FB input corresponding to the other of the first set of antennas 141 or the second set of antennas 143. The output switches 153-155 may each select an RX output of the other of the first set of antennas 141 or the second set of antennas 143. For example, the first input switch 112 may select one of the TX input 171 or the TX input 175. For example, the control circuitry 104 may provide a first switching input (e.g., an input 299) to the first input switch 112. A first value (e.g., 0) of the first switching input may indicate a first mode. A second value (e.g., 1) of the first switching input may indicate a second mode. The first input switch 112 may select the TX input 171 in response to receiving the first switching input having the first value (e.g., 0). Alternatively, the first input switch 112 may select the TX input 175 in response to receiving the first switching input having the second value (e.g., 1).

The second input switch 114 may select one of the TX input 173 or the TX input 177. For example, the control circuitry 104 may provide the first switching input to the second input switch 114. The second input switch 114 may select the TX input 173 in response to receiving the first switching input having the first value (e.g., 0). Alternatively, the second input switch 114 may select the TX input 177 in response to receiving the first switching input having the second value (e.g., 1).

The FB switch 212 may select a FB input 280 or an FB input 284. For example, the control circuitry 104 may provide the first switching input to the FB switch 212. The FB switch 212 may select the FB input 284 in response to receiving the first switching input having the first value (e.g., 0). Alternatively, the FB switch 212 may select the FB input 280 in response to receiving the first switching input having the second value (e.g., 1).

The FB switch 214 may select a FB input 282 or an FB input 286. For example, the control circuitry 104 may provide the first switching input to the FB switch 214. The FB switch 214 may select the FB input 286 in response to receiving the first switching input having the first value (e.g., 0). Alternatively, the FB switch 214 may select the FB input 282 in response to receiving the first switching input having the second value (e.g., 1).

The FB switch 216 may select the FB input 282 or the FB input 286. For example, the control circuitry 104 may provide the first switching input to the FB switch 216. The FB switch 216 may select the FB input 286 in response to receiving the first switching input having the first value (e.g., 0). Alternatively, the FB switch 216 may select the FB input 282 in response to receiving the first switching input having the second value (e.g., 1).

The FB switch 218 may select the FB input 280 or the FB input 284. For example, the control circuitry 104 may provide the first switching input to the FB switch 218. The FB switch 218 may select the FB input 284 in response to receiving the first switching input having the first value (e.g., 0). Alternatively, the FB switch 218 may select the FB input 280 in response to receiving the first switching input having the second value (e.g., 1).

The output switch 153 may select the RX output 180 or the RX output 184. For example, the control circuitry 104 may provide the first switching input to the output switch 153. The output switch 153 may select the RX output 184 in response to receiving the first switching input having the first value (e.g., 0). Alternatively, the output switch 153 may select the RX output 180 in response to receiving the first switching input having the second value (e.g., 1).

The output switch 155 may select the RX output 182 or the RX output 186. For example, the control circuitry 104 may provide the first switching input to the output switch 155. The output switch 155 may select the RX output 182 in response to receiving the first switching input having the first value (e.g., 0). Alternatively, the output switch 155 may select the RX output 186 in response to receiving the first switching input having the second value (e.g., 1).

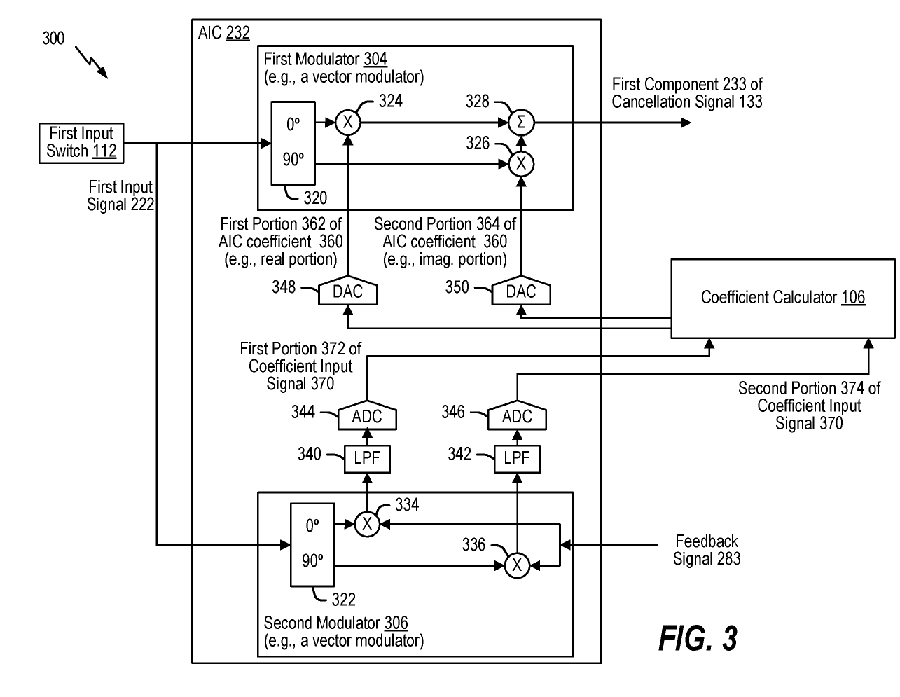

The first set of AIC circuits 132 (e.g., the AIC circuit 232, the AIC circuit 238, or both) may output components of the cancellation signal 133. For example, the AIC circuit 232 may receive a first input signal 222 (e.g., a reference signal) via the first input switch 112. The first input signal 222 may correspond to a signal transmitted by the TX antenna 170 when the TX input 171 is selected by the first input switch 112 or to a signal transmitted by the RX antenna 174 when the TX input 175 is selected by the first input switch 112. The AIC circuit 232 may receive a FB signal 283 (e.g., a radio frequency (RF) signal or a baseband signal) from the FB switch 212. The FB signal 283 may include a feedback signal corresponding to the RX antenna 174 when the FB input 284 is selected by the FB switch 212 or to the TX antenna 170 when the FB input 280 is selected by the FB switch 212. The AIC circuit 232 may generate a first component 233 of the cancellation signal 133 based on the first input signal 222 and the FB signal 283, as further described with reference to FIG. 3. The AIC circuit 232 may provide the first component 233 of the cancellation signal 133 to the cancellation input 151 of the output switch 153.

As another example, the AIC circuit 238 may receive a second input signal 224 via the second input switch 114. The second input signal 224 may correspond to a signal transmitted by the TX antenna 172 when the TX input 173 is selected by the second input switch 114 or to a signal transmitted by the RX antenna 176 when the TX input 177 is selected by the second input switch 114. The AIC circuit 238 may receive the FB signal 283 from the FB switch 218. The AIC circuit 238 may generate a second component 235 of the cancellation signal 133 based on the second input signal 224 and the FB signal 283. The AIC circuit 238 may provide the second component 235 of the cancellation signal 133 to the cancellation input 151 of the output switch 153.

The second set of AIC circuits 134 (e.g., the AIC circuit 234, the AIC circuit 236, or both) may output components of the cancellation signal 135. For example, the AIC circuit 236 may receive the second input signal 224 via the second input switch 114. The AIC circuit 236 may receive a FB signal 285 (e.g., a RF signal or a baseband signal) from the FB switch 216. The FB signal 285 may include a feedback signal corresponding to the RX antenna 176 when the FB input 286 is selected by the FB switch 216 or to the TX antenna 172 when the FB input 282 is selected by the FB switch 216. The AIC circuit 236 may generate a first component 237 of the cancellation signal 135 based on the second input signal 224 and the FB signal 285. The AIC circuit 236 may provide the first component 237 of the cancellation signal 135 to the cancellation input 152 of the output switch 155. As another example, the AIC circuit 234 may receive the first input signal 222 via the first input switch 112. The AIC circuit 234 may receive the FB signal 285 from the FB switch 214. The AIC circuit 234 may generate a second component 239 of the cancellation signal 135 based on the first input signal 222 and the FB signal 285. The AIC circuit 234 may provide the second component 239 of the cancellation signal 135 to the cancellation input 152 of the output switch 155.

The cancellation input 151 may receive the cancellation signal 133 from the first set of AIC circuits 132. For example, the cancellation input 151 may receive the first component 233 of the cancellation signal 133 from the AIC circuit 232, the second component 235 of the cancellation signal 133 from the AIC circuit 238, or both. The output switch 153 may output the cancellation signal 133. For example, the output switch 153 may output the cancellation signal 133 to the RX antenna 174 when the RX output 184 is selected by the output switch 153 or to the TX antenna 170 when the RX output 180 is selected by the output switch 153.

The cancellation signal 133 may cancel at least a portion of interference from the first input signal 222, the second input signal 224, or both, in a signal received by the RX antenna 174 (when the RX output 184 is selected by the output switch 153) or by the TX antenna 170 (when the RX output 180 is selected by the output switch 153). For example, the first component 233 of the cancellation signal 133 may cancel at least a portion of interference from the first input signal 222 in a signal received by an antenna coupled to the output switch 153. The second component 235 of the cancellation signal 133 may cancel at least a portion of interference from the second input signal 224 in the signal received by the antenna coupled to the output switch 153.

The cancellation input 152 may receive the cancellation signal 135 from the second set of AIC circuits 134. For example, the cancellation input 152 may receive the first component 237 of the cancellation signal 135 from the AIC circuit 236, the second component 239 of the cancellation signal 135 from the AIC circuit 234, or both. The output switch 155 may output the cancellation signal 135. For example, the output switch 155 may output the cancellation signal 135 to the RX antenna 176 when the RX output 186 is selected by the output switch 155 or to the TX antenna 172 when the RX output 182 is selected by the output switch 155.

The cancellation signal 135 may cancel at least a portion of interference from the first input signal 222, the second input signal 224, or both, in a signal received by the RX antenna 176 (when the RX output 186 is selected by the output switch 155) or by the TX antenna 172 (when the RX output 182 is selected by the output switch 155). For example, the first component 237 of the cancellation signal 135 may cancel at least a portion of interference from the second input signal 224 in a signal received by an antenna coupled to the output switch 155. The second component 239 of the cancellation signal 135 may cancel at least a portion of interference from the first input signal 222 in the signal received by the antenna coupled to the output switch 155.

The system 200 may thus enable at least partial cancellation of interference in signals received by receiving antennas from signals transmitted by one or more transmitting antennas. The input switches 112-114, the FB switches 212-218, and the output switches 153-155 may reduce a number of AIC circuits as compared to having a dedicated AIC circuit for each combination of TX input and RX output.

Referring to FIG. 3, a particular illustrative example of a system is shown and generally designated 300. The system 300 may correspond to the system 100 of FIG. 1, the system 200 of FIG. 2, or both. For example, one or more components of the system 300 may be included in the system 100, the system 200, or both.

The AIC circuit 232 includes a first modulator 304 configured to generate the first component 233 of the cancellation signal 133, as described herein. The first modulator 304 may be coupled to the coefficient calculator 106. The coefficient calculator 106 may be configured to generate an AIC coefficient 360. The AIC circuit 232 may also include a second modulator 306 (e.g., a vector modulator) coupled to the coefficient calculator 106. The coefficient calculator 106 may be configured to generate the AIC coefficient 360 based at least in part on a coefficient input signal 370 received from the second modulator 306. The first modulator 304, the second modulator 306, or both, may be coupled to the first input switch 112. The second modulator 306 may be configured to generate the coefficient input signal 370 based on the first input signal 222 and the feedback signal 283, as described herein.

The first modulator 304 may include a polyphase component 320 (e.g., a polyphase filter), a mixer 324, a mixer 326, an adder 328, or a combination thereof. The second modulator 306 may include a polyphase component 322 (e.g., a polyphase filter), a mixer 334, a mixer 336, or a combination thereof. The mixer 334 may be coupled, via a low-pass filter (LPF) 340 and an analog-to-digital converter (ADC) 344, to the coefficient calculator 106. The mixer 336 may be coupled, via a LPF 342 and an ADC 346, to the coefficient calculator 106. The coefficient calculator 106 may be coupled, via a digital-to-analog converter (DAC) 348, to the mixer 324. The coefficient calculator 106 may be coupled, via a DAC 350, to the mixer 326. The adder 328 may be coupled to the mixer 324 and to the mixer 326.

The first modulator 304, the second modulator 306, or both, may be implemented in a number of ways, such as active or passive, using multipliers or amplifiers, using polyphase filters or demodulating signals to baseband, multiplying and modulating to passband, etc. Hardware (e.g., circuitry) may be shared between various TX and RX antenna paths using switching, routing, or both.

During operation, the second modulator 306 (e.g., a vector modulator) may receive the first input signal from the first input switch 112, the feedback signal 283, or both. The polyphase component 322 may generate an in-phase signal output and a quadrature signal output relative to the first input signal 222. For example, the polyphase component 322 may generate the in-phase signal output by passing the first input signal 222 with no phase shift (e.g., a 0 degree phase shift). The polyphase component 322 may generate the quadrature signal output by applying a phase shift (e.g., a 90 degree phase shift) to the first input signal 222. The polyphase component 322 may provide the in-phase signal output to the mixer 334, the quadrature signal output to the mixer 336, or both. The mixer 334 and the mixer 336 may receive the feedback signal 283. An output of the mixer 334 is provided to the LPF 340. The ADC 344 outputs a first portion 372 of the coefficient input signal 370 based on an output of the LPF 340. For example, the ADC 344 may generate the first portion 372 of the coefficient input signal 370 by converting an output of the LPF 340 to a baseband signal. An output of the mixer 336 is provided to the LPF 342. The ADC 346 outputs a second portion 374 of the coefficient input signal 370 based on an output of the LPF 342. For example, the ADC 346 may generate the second portion 374 of the coefficient input signal 370 by converting an output of the LPF 342 to a baseband signal.

The coefficient calculator 106 receives the coefficient input signal 370 from the second modulator 306. For example, the coefficient calculator 106 receives the first portion 372 of the coefficient input signal 370 from the ADC 344, the second portion 374 of the coefficient input signal 370 from the ADC 346, or both. The coefficient calculator 106 may perform a coefficient control algorithm to generate an AIC coefficient 360 based on the coefficient input signal 370, one or more additional coefficient input signals received from one or more additional AIC circuits (e.g., the AIC circuit 234, the AIC circuit 236, or the AIC circuit 238), or a combination thereof. The coefficient input signal 370 may indicate interference (e.g., a correlation) between the first input signal 222 and the feedback signal 283. The coefficient calculator 106 may generate the AIC coefficient 360 to reduce (e.g., eliminate) the interference (e.g., the correlation).

The first modulator 304 may receive the AIC coefficient 360 from the coefficient calculator 106. For example, the DAC 348 may generate a first portion 362 of the AIC coefficient 360 by converting a first output of the coefficient calculator 106 from digital to analog. The mixer 324 may receive the first portion 362 (e.g., a real portion) of the AIC coefficient 360. The DAC 350 may generate a second portion 364 of the AIC coefficient 360 by converting a second output of the coefficient calculator 106 from digital to analog. The coefficient calculator 106 may generate a digital coefficient. For example, the first output of the coefficient calculator 106 may correspond to a digital value and the second output of the coefficient calculator 106 may correspond to a digital value. The DAC 348 and the DAC 350 may generate the AIC coefficient 360 by converting the digital coefficient to an analog coefficient. The mixer 326 may receive the second portion 364 (e.g., an imaginary portion) of the AIC coefficient 360.

The mixer 324 may also receive an in-phase signal output relative to the first input signal 222 from the polyphase component 320. The mixer 326 may receive a quadrature signal output relative to the first input signal 222 from the polyphase component 320. The adder 328 may generate the first component 233 of the cancellation signal 133 by combining an output of the mixer 324 and an output of the mixer 326.

In some implementations, the coefficient calculator 106 may update the AIC coefficient 360 based on observed channel changes. For example, the coefficient calculator 106 may update the AIC coefficient 360 based on expiration of a time period subsequent to a previous update of the AIC coefficient 360. To illustrate, the coefficient calculator 106 may, at a first update time, update the AIC coefficient 360 to indicate a first coefficient value at the AIC circuit 232. The coefficient calculator 106 may, in response to determining, at a first time, that a difference between the first time and the first update time is greater than a first duration indicated by a threshold, update the AIC coefficient 360 to indicate a second coefficient value at the AIC circuit 232. The coefficient calculator 106 may determine that the first coefficient value is the same as the second coefficient value, indicating substantially stable channel conditions. The coefficient calculator 106 may, in response to determining that the first coefficient value is the same as the second coefficient value, update the threshold to indicate a greater duration than the first duration.

Alternatively, the coefficient calculator 106 may determine that the first coefficient value is distinct from the second coefficient value, indicating changes in channel conditions. The coefficient calculator 106 may, in response to determining that the first coefficient value is distinct from the second coefficient value, update the threshold to indicate a lower duration than the first duration. In some implementations, a default value of the threshold may indicate a lower duration when the device 102 corresponds to an access point (AP) than when the device 102 corresponds to user equipment (UE).

In some implementations, the coefficient calculator 106 may update the AIC coefficient 360 in response to detecting a change in the MIMO configuration of the device 102. For example, the coefficient calculator 106 may detect the change in the MIMO configuration in response to detecting a change in a relative position or a change in TX/RX groupings of two or more of the TX antenna 170, the TX antenna 172, the RX antenna 174, or the RX antenna 176 of FIG. 1.

In some implementations, the coefficient calculator 106 may update the AIC coefficient 360 in response to determining that the feedback signal 283 fails to satisfy a criterion. For example, the coefficient calculator 106 may determine that the feedback signal 283 fails to satisfy the criterion based on a characteristic of the coefficient input signal 370. To illustrate, the coefficient calculator 106 may determine that the feedback signal 283 fails to satisfy the criterion in response to determining that the coefficient input signal 370 indicates a particular correlation between the feedback signal 283 and the first input signal 222 and that the particular correlation is higher than a threshold correlation.

In some implementations, the first modulator 304 may share a polyphase component (e.g., the polyphase component 320 or the polyphase component 322) with the second modulator 306. For example, the polyphase component 320 may provide the quadrature signal output to the mixer 336 in addition to the mixer 326, the in-phase signal output to the mixer 334 in addition to the mixer 324, or both.

In some implementations, multiple AIC circuits may share a polyphase component (e.g., the polyphase component 320 or the polyphase component 322). For example, the polyphase component 320 of the AIC circuit 232 may provide the quadrature signal output to the mixer 336, the mixer 326, or both, of the AIC circuit 234. The polyphase component 320 of the AIC circuit 232 may provide the in-phase signal output to the mixer 334, the mixer 324, or both, of the AIC circuit 234.

The system 300 may enable an AIC to generate a component of a cancellation signal based on an input signal and a feedback signal. The cancellation signal may be based on a coefficient received from a coefficient calculator.

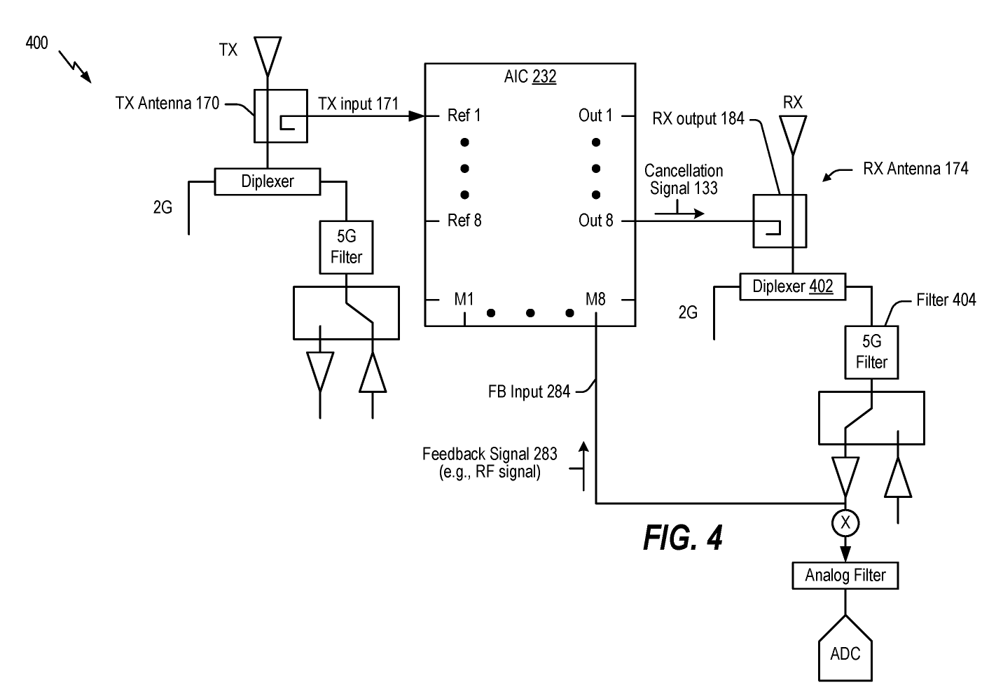

Referring to FIG. 4, a particular illustrative example of a system is shown and generally designated 400. The system 400 may correspond to the system 100 of FIG. 1, the system 200 of FIG. 2, the system 300 of FIG. 3, or a combination thereof. For example, one or more components of the system 400 may be included in one or more of the systems 100-300.

The feedback signal 283 may include a RF signal. For example, the RX antenna 174 may be coupled to a diplexer 402. The RX antenna 174 may be configured to provide a received signal to the diplexer 402. The diplexer 402 may receive, via the RX antenna 174, the cancellation signal 133 from the first set of AIC circuits 132, as described with reference to FIG. 1, the received signal from the RX antenna 174, or both. The diplexer 402 may provide the cancellation signal 133, the received signal, or both, to a filter 404 (e.g., a fifth generation (5G) filter). An output of the filter 404 may be provided as the feedback signal 283 at the FB input 284 to the AIC circuit 232. The system 400 may thus enable the AIC circuit 232 to generate the cancellation signal 133 based on an RF feedback signal.

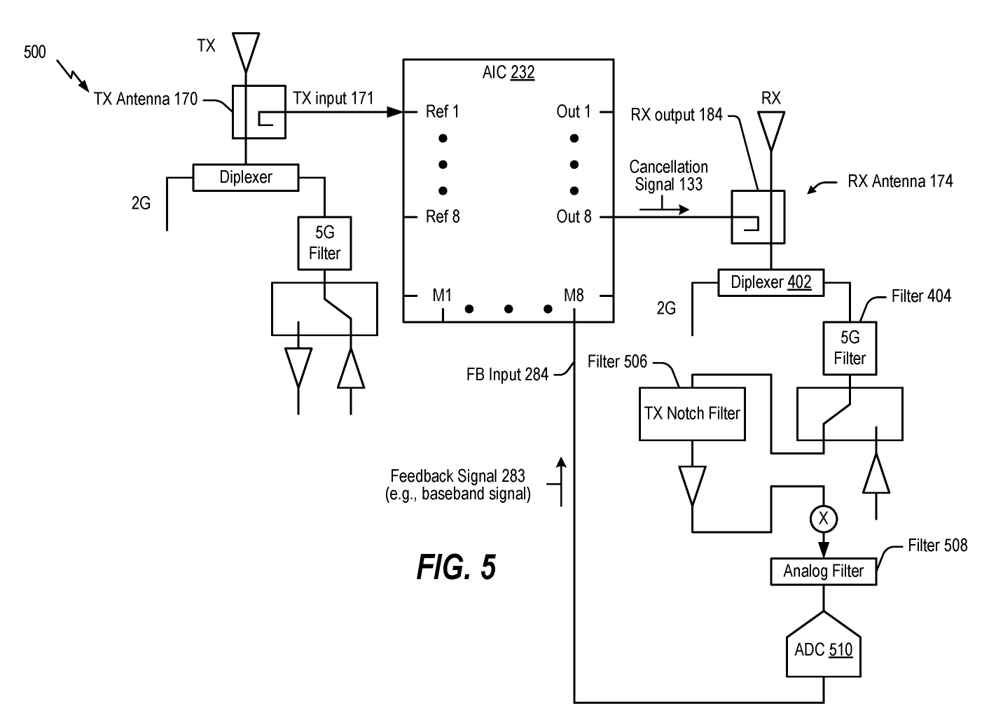

Referring to FIG. 5, a particular illustrative example of a system is shown and generally designated 500. The system 500 may correspond to the system 100 of FIG. 1, the system 200 of FIG. 2, the system 300 of FIG. 3, the system 400 of FIG. 4, or a combination thereof. For example, one or more components of the system 500 may be included in one or more of the systems 100-400.

The system 500 differs from the system 400 in that the feedback signal 283 may include a baseband signal. An output of the filter 404 is further filtered, via a filter 506 (e.g., a TX Notch filter), mixed to baseband and filtered at a filter 508 (e.g., an analog filter), and the filtered baseband signal is converted from analog to digital by an ADC 510 to generate the feedback signal 283.

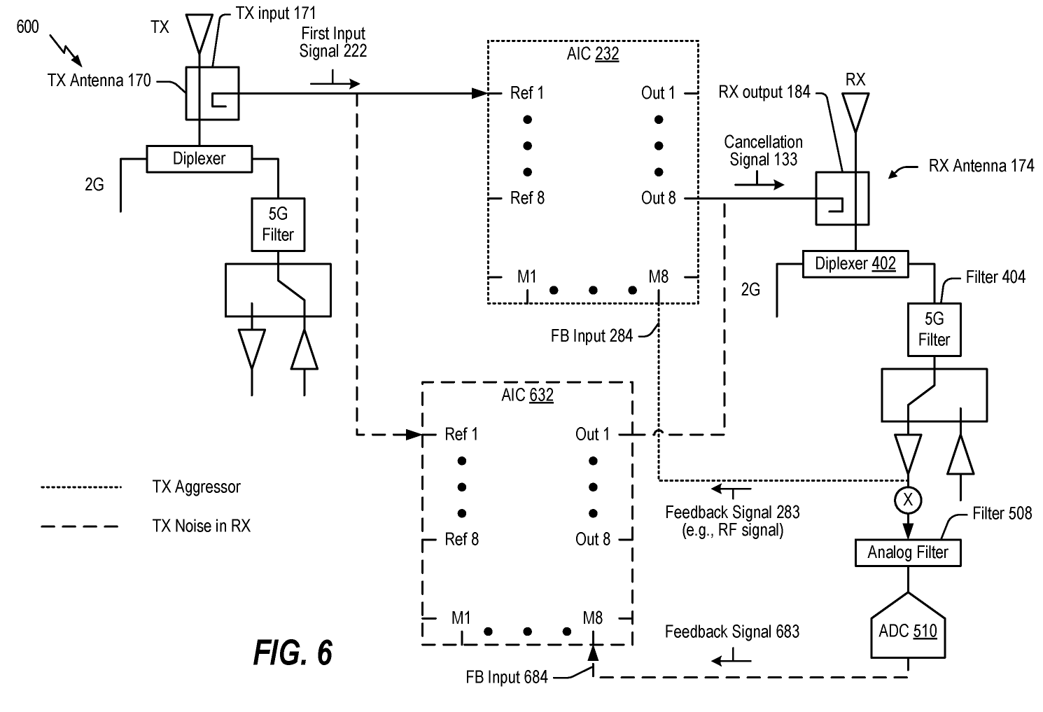

Referring to FIG. 6, a particular illustrative example of a system is shown and generally designated 600. The system 600 may correspond to the system 100 of FIG. 1, the system 200 of FIG. 2, the system 300 of FIG. 3, the system 400 of FIG. 4, the system 500 of FIG. 5, or a combination thereof. For example, one or more components of the system 600 may be included in one or more of the systems 100-500.

The system 600 includes an AIC circuit 632 coupled to the TX input 171 and to the RX output 184. The AIC circuit 232 may receive the feedback signal 283 from the filter 404, as described with reference to FIG. 4. For example, the feedback signal 283 may include a RF signal. The AIC circuit 632 may receive a feedback signal 683, via a FB input 684, from the ADC 510. An output of the filter 404 may be mixed to baseband and filtered by the filter 508 (e.g., an analog filter), and the filtered baseband output may be provided to the ADC 510. The ADC 510 may generate the feedback signal 683 by converting the filtered output from analog to digital. The AIC circuit 632 may be configured to perform similar operations as the AIC circuit 232. For example, the AIC circuit 232 may generate the first component 233 of the cancellation signal 133 based on the first input signal 222 and the feedback signal 283, as described with reference to FIG. 3. The AIC circuit 632 may generate a second component of the cancellation signal 133 based on the first input signal 222 and a feedback signal (e.g., the feedback signal 683), as described with reference to FIG. 3. The first component 233 of the cancellation signal 133 may reduce interference from the first input signal 222 in a signal received by the RX antenna 174. The second component of the cancellation signal 133 may reduce TX noise in the signal received by the RX antenna 174. The system 600 may thus generate the cancellation signal 133 based on a baseband feedback signal and an analog feedback signal.

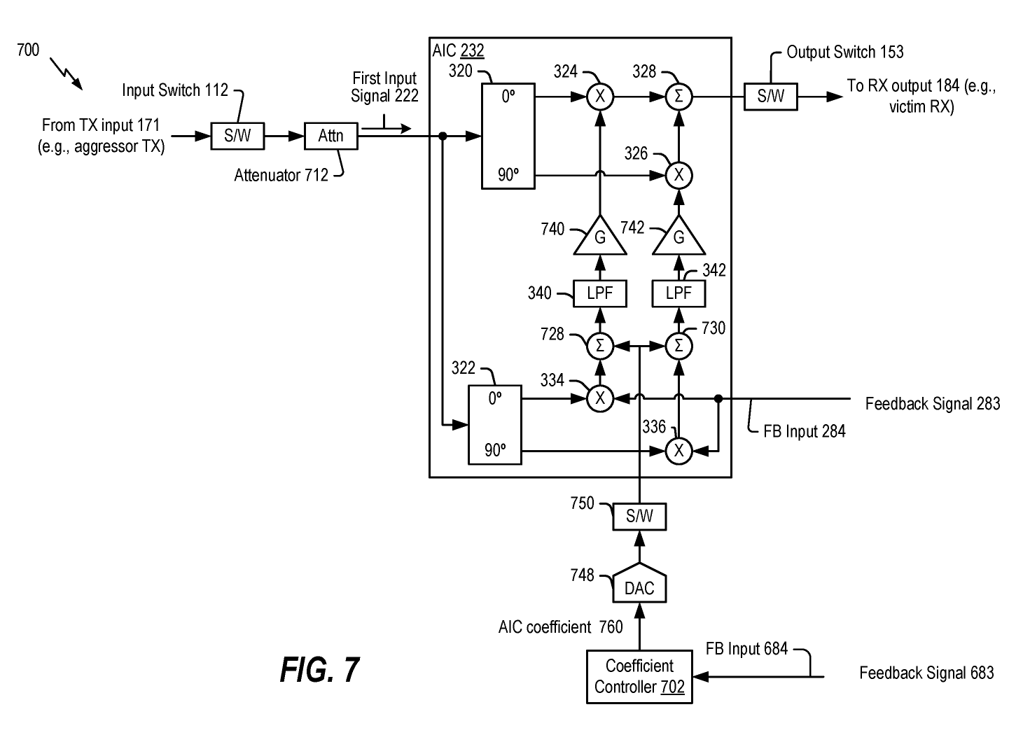

Referring to FIG. 7, a particular illustrative example of a system is shown and generally designated 700. The system 700 may correspond to the system 100 of FIG. 1, the system 200 of FIG. 2, the system 300 of FIG. 3, the system 400 of FIG. 4, the system 500 of FIG. 5, the system 600 of FIG. 6, or a combination thereof. For example, one or more components of the system 700 may be included in one or more of the systems 100-600.

The system 700 includes an attenuator 712 coupled to the first input switch 112. An output of the attenuator 712 may be coupled to the polyphase component 320, the polyphase component 322, or both. The mixer 334 may be coupled to an adder 728. The mixer 336 may be coupled to an adder 730. The adder 728, the adder 730, or both, may also be coupled to a switch 750. An output of the adder 728 may be coupled to the LPF 340. An output of the adder 730 may be coupled to the LPF 342. An output of the LPF 340 may be coupled via a gain component 740 (e.g., an amplifier) to the mixer 324. An output of the LPF 342 may be coupled via a gain component 742 to the mixer 326. The switch 750 may be coupled, via a DAC 748, to a coefficient controller 702.

During operation, the polyphase component 320, the polyphase component 322, or both, may receive the first input signal 222, via the attenuator 712, from the first input switch 112. The attenuator 712 may generate the first input signal 222 by reducing amplitude of a signal received from the TX input 171. The mixer 334 may generate an output based on the first input signal 222 and the feedback signal 283, as described with reference to FIG. 3. The mixer 336 may generate an output based on the first input signal 222 and the feedback signal 283, as described with reference to FIG. 3. The adder 728 may generate an output based on the output of the mixer 334, an output of the switch 750, or both. The adder 730 may generate an output based on the output of the mixer 336, the output of the switch 750, or both. The LPF 340 may filter the output of the adder 728 and may provide the filtered output to the gain component 740. The LPF 342 may filter the output of the adder 730 and may provide the filtered output to the gain component 742. The gain component 740 may generate the first portion 362 of the AIC coefficient 360 of FIG. 3 by applying a first gain to the output of the LPF 340. The gain component 742 may generate the second portion 364 of the AIC coefficient 360 of FIG. 3 by applying a second gain to the output of the LPF 342. In some implementations, the first gain, the second gain, or both, may be determined by the coefficient calculator 106 by performing a coefficient control algorithm based on the output of the LPF 340, the output of the LPF 342, or both.

The output of the switch 750 may correspond to digital coefficient generation. For example, the coefficient controller 702 may receive the FB signal 683 from the FB input 684 of FIG. 6. The FB signal 683 may correspond to a baseband signal, as described with reference to FIG. 6. The coefficient controller 702 may generate an AIC coefficient 760 by performing a coefficient control algorithm based at least in part on the FB signal 683. The coefficient controller 702 may provide the AIC coefficient 760 to the DAC 748. The DAC 748 may generate an output by converting the AIC coefficient 760 from digital to analog. When the DAC 748 is selected by the switch 750, the switch 750 may provide the output of the DAC 748 to the adder 728, the adder 730, or both. For example, the switch 750 may provide a first portion (e.g., a real portion) of the output of the DAC 748 to the adder 728, may provide a second portion (e.g., an imaginary portion) of the output of the DAC 748 to the adder 730, or both.

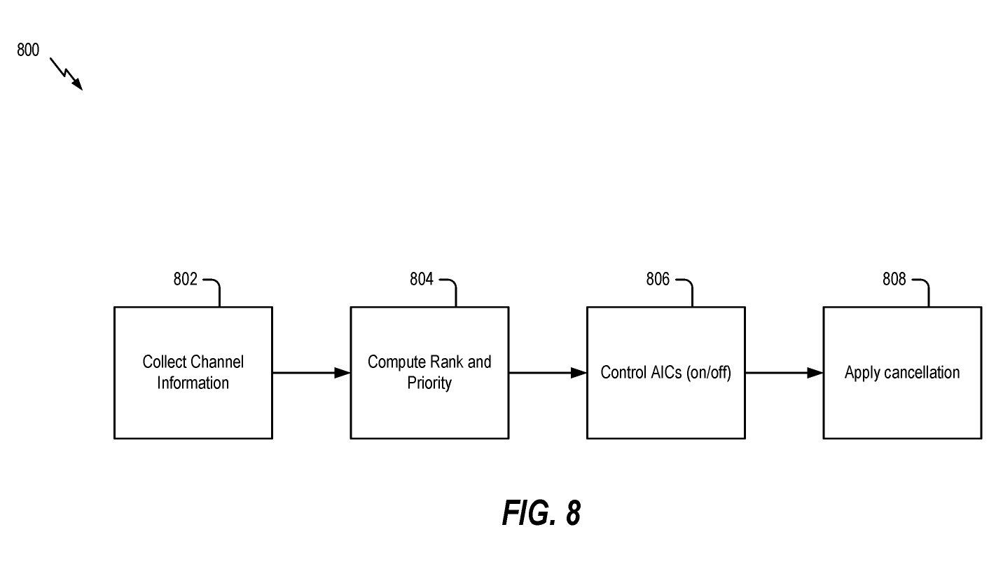

Referring to FIG. 8, a particular aspect of a method of operation is shown and generally designated 800. The method 800 may be performed by the control circuitry 104 of FIG. 1.

The method 800 includes collecting channel information, at 802. For example, the control circuitry 104 of FIG. 1 may collect channel information corresponding to a first channel, a second channel, a third channel, a fourth channel, or a combination thereof. To illustrate, the first input switch 112 may be associated with a transmission on the first channel, the second input switch 114 may be associated with a transmission on the second channel, the output switch 153 may be associated with a signal reception on the third channel, the output switch 155 may be associated with a signal reception on the fourth channel, or a combination thereof. The channel information may indicate whether a channel (e.g., the first channel, the second channel, the third channel, or the fourth channel) corresponds to a first type of signal (e.g., a long-term evolution (LTE) signal) or a second type of signal (e.g., a wireless fidelity (WiFi) signal).

The method 800 also includes computing rank and priority, at 804. For example, the control circuitry 104 of FIG. 1 may generate the priority data 194 indicating relative priority of two or more of the first channel, the second channel, the third channel, or the fourth channel. The control circuitry 104 may generate the priority data 194 based on the channel information. For example, a channel corresponding to the first type of signal may have higher priority than another channel corresponding to the second type of signal, or vice versa. Transmission on a channel may have higher priority than reception on another channel, or vice versa.

The method 800 further includes controlling AIC circuits, at 806. For example, the control circuitry 104 of FIG. 1 may selectively deactivate at least one AIC circuit based on the priority data 194. To illustrate, the control circuitry 104 may deactivate the second set of AIC circuits 134 in response to determining that the priority data 194 indicates that the fourth channel has a lowest relative priority. In some implementations, the control circuitry 104 may deactivate the AIC circuit 234 and the AIC circuit 236 in response to determining that the priority data 194 indicates that the second channel has a lowest relative priority or that the second channel has a lower priority than a priority of the first channel.

The method 800 also includes applying cancellation, at 808. For example, the control circuitry 104 of FIG. 1 may activate the output switch 153 to apply the cancellation input 151, the output switch 155 to apply the cancellation input 152, or both.

The method 800 thus enables the control circuitry 104 to selectively activate AIC circuits based on channel priority. In some implementations, the device 102 may include fewer available AIC circuits than a number of channels. The control circuitry 104 may operate the AIC circuits to generate cancellation signals corresponding to channels having higher relative priority.

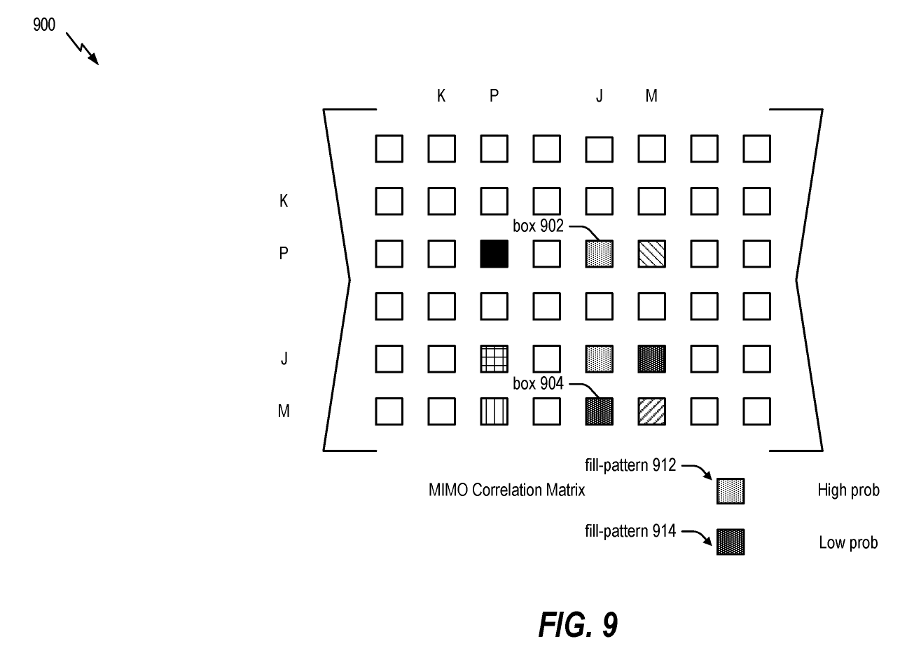

Referring to FIG. 9, a correlation matrix is shown and generally designated 900. The control circuitry 104 of FIG. 1 may generate the correlation matrix 900 (e.g., a MIMO correlation matrix).

Each of the first set of antennas 141 of FIG. 1 (e.g., the TX antenna 170 or the TX antenna 172) may transmit a reference signal (e.g., an input signal) including a sequence of pilot symbols. For example, the TX antenna 170 may generate the first input signal 222 including a first sequence of pilot symbols. The TX antenna 172 may generate the second input signal 224 including a second sequence of pilot symbols. Each receiving antenna of the second set of antennas 143 of FIG. 1 (e.g., the RX antenna 174 or the RX antenna 176) may receive the reference signal.

The control circuitry 104 may determine a strength of the reference signal (e.g., a coupling channel strength) based on pilot symbols received by the receiving antenna. For example, the control circuitry 104 may determine a first strength based on the first sequence of pilot symbols received via the RX antenna 174. The control circuitry 104 may determine a second strength based on the first sequence of pilot symbols received via the RX antenna 176. The control circuitry 104 may determine a third strength based on the second sequence of pilot symbols received via the RX antenna 174. The control circuitry 104 may determine a fourth strength based on the second sequence of pilot symbols received via the RX antenna 176.

In some implementations, the AIC circuit 232 of FIG. 2 may determine the first strength of a first coupling channel based on the first input signal 222 and the FB signal 283. For example, the feedback signal 283 may include a component corresponding to the first sequence of pilot symbols. The control circuitry 104 may determine the first strength based on a comparison of the first input signal 222 and the feedback signal 283. The AIC circuit 234 may determine the second strength of a second coupling channel based on the first input signal 222 and the FB signal 285. The AIC circuit 238 may determine the third strength of a third coupling channel based on the second input signal 224 and the FB signal 283. The AIC circuit 236 may determine the fourth strength of a fourth coupling channel based on the second input signal 224 and the FB signal 285.

The control circuitry 104 may generate the correlation matrix 900 based on the first strength, the second strength, the third strength, the fourth strength, or a combination thereof. For example, each column of the correlation matrix 900 may correspond to a transmitting antenna (e.g., the TX antenna 170, the TX antenna 172, or both). Each row of the correlation matrix 900 may correspond to a receiving antenna (e.g., the RX antenna 174, the RX antenna 176, or both). A first entry of the correlation matrix 900 corresponding to the TX antenna 170 and the RX antenna 174 may indicate the first strength. A second entry of the correlation matrix 900 corresponding to the TX antenna 170 and the RX antenna 176 may indicate the second strength. A third entry of the correlation matrix 900 corresponding to the TX antenna 172 and the RX antenna 174 may indicate the third strength. A fourth entry of the correlation matrix 900 corresponding to the TX antenna 172 and the RX antenna 176 may indicate the fourth strength.

The control circuitry 104 may determine a first number of taps based on the first strength, a second number of taps based on the second strength, a third number of taps based on the third strength, a fourth number of taps based on the fourth strength, or a combination thereof. For example, the control circuitry 104 may set the first number of taps to indicate a single tap in response to determining that the first strength is less than or equal to a threshold. Alternatively, the control circuitry 104 may set the first number of taps to indicate multiple taps in response to determining that the first strength is greater than the threshold. As described herein, performing “multiple tapping” refers to applying multiple taps to a signal (e.g., the first input signal 222).

The first component 233 of the cancellation signal 133 of FIGS. 1-2 may be generated by applying the first number of taps to the first input signal 222, the FB signal 283, or both. The second component 239 of the cancellation signal 135 may be generated by applying the second number of taps to the first input signal 222, the FB signal 285, or both. The second component 235 of the cancellation signal 133 may be generated by applying the third number of taps to the second input signal 224, the FB signal 283, or both. The first component 237 of the cancellation signal 135 may be generated by applying the fourth number of taps to the second input signal 224, the FB signal 285, or both.

In some implementations, applying a particular number of taps (e.g., the first number of taps) to a particular signal (e.g., the first input signal) may include generating a plurality of delayed signals based on the particular signal and generating components of a cancellation signal (e.g., the cancellation signal 133) based on the delayed signals. The count of the plurality of delayed signals may correspond to the particular number. For example, the control circuitry 104 may activate a plurality of AIC circuits corresponding to the first number of taps. Each of the AIC circuits may receive a delayed input signal from a corresponding delay element. The delay element may add a particular delay to the first input signal. Each of the AIC circuits may generate a component of the cancellation signal 133 based on the delayed input signal and the feedback signal 283, as described with reference to FIG. 2.

In some implementations, the device 102 may include a first number of AIC circuits available to perform taps. The control circuitry 104 may determine the first number of taps based on the first strength, the second strength, the third strength, the fourth strength, or a combination thereof. For example, the control circuitry 104 may prioritize higher strengths of the first strength, the second strength, the third strength, and the fourth strength over lower strengths. To illustrate, the control circuitry 104 may determine that the first strength indicates a relatively higher strength among the first strength, the second strength, the third strength, and the fourth strength. The control circuitry 104 may set the first number of taps to the lower of the first number of taps and the first number of available AIC circuits. The control circuitry 104 may update the first number of available AIC circuits by subtracting the first number of taps. The control circuitry 104 may, in response to determining that the second strength indicates a relatively higher strength among the second strength, the third strength, and the fourth strength, set the second number of taps to the lower of the second number of taps and the first number of available AIC circuits, and so on, until the first number of available AIC circuits reaches a threshold (e.g., 0).

The correlation matrix 900 may enable generation of cancellation signals based on strength of reference (e.g., input) signals. The strength of the input signals may be determined during training. The cancellation signals may be based on the strength of the input signals that is determined in advance during training as compared to determining the strength on-the-fly. A cancellation signal corresponding to a relatively stronger input signal may correspond to a higher (or lower) number of taps.

An entry of the MIMO correlation matrix 900 may indicate a probability that a corresponding transmitting antenna causes interference with a corresponding receiving antenna. For example, the entry may be represented by a box. To illustrate, as shown in FIG. 9, a box 902 may represent a first entry of the MIMO correlation matrix 900 corresponding to a transmitting antenna (J) and to a first receiving antenna (P). A box 904 may represent a second entry of the MIMO correlation matrix 900 corresponding to the transmitting antenna (J) and to a second receiving antenna (M). A particular fill-pattern of the box may indicate a probability that a corresponding transmitting antenna interferes with a corresponding receiving antenna. For example, the box 902 may have a fill-pattern 912 indicating a first probability (e.g., a higher probability) of the transmitting antenna (J) interfering with the first receiving antenna (P). The box 904 may have a fill-pattern 914 indicating a second probability (e.g., a lower probability) of the transmitting antenna (J) interfering with the second receiving antenna (M). An input signal from the transmitting antenna (J) may have a higher probability of interfering with a signal received by the first receiving antenna (P) than with a signal received by the second receiving antenna (M). A probability may indicate strength of an input signal of the corresponding transmitting antenna as received by the corresponding receiving antenna. For example, the input signal received by the first receiving antenna (P) may be stronger than the input signal received by the second receiving antenna (M).

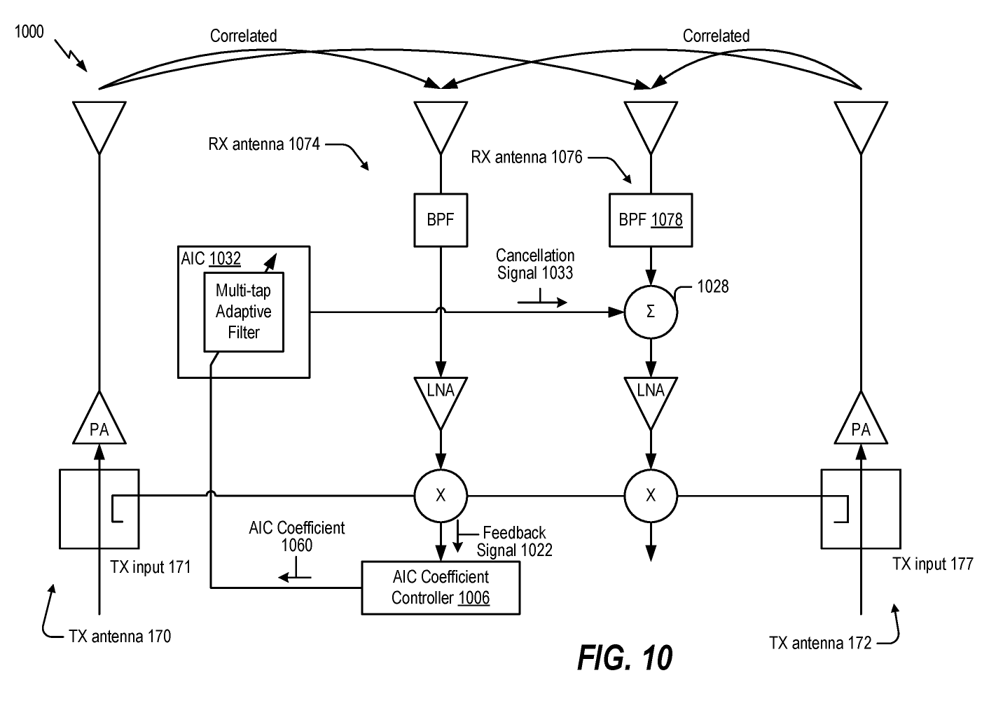

Referring to FIG. 10, a particular illustrative example of a system is shown and generally designated 1000. The system 1000 may correspond to the system 100 of FIG. 1, the system 200 of FIG. 2, the system 300 of FIG. 3, the system 400 of FIG. 4, the system 500 of FIG. 5, the system 600 of FIG. 6, the system 700 of FIG. 7, or a combination thereof. For example, one or more components of the system 1000 may be included in one or more of the systems 100-700.

The system 1000 includes the TX antenna 170, the TX antenna 172, an RX antenna 1074, and an RX antenna 1076. The system 1000 may also include an AIC coefficient controller 1006, an AIC circuit 1032 (e.g., a multi-tap adaptive filter), or both. The RX antenna 1076 may be coupled to a band-pass filter (BPF) 1078, an adder 1028, or both.

Because interference between the TX antenna 170 and the RX antenna 1074 is correlated to interference between the TX antenna 170 and the RX antenna 1076 and interference between the TX antenna 172 and the RX antenna 1074 is correlated to interference between the TX antenna 172 and the RX antenna 1076, a cancellation signal for the RX antenna 1076 may be based on a feedback signal corresponding to the RX antenna 1074. For example, the AIC coefficient controller 1006 may receive a FB signal 1022 corresponding to the RX antenna 1074. The AIC coefficient controller 1006 may perform a coefficient control algorithm to generate an AIC coefficient 1060 based on the feedback signal 1022. The AIC coefficient controller 1006 may provide the AIC coefficient 1060 to the AIC circuit 1032. The AIC circuit 1032 may generate a component of a cancellation signal (e.g., a cancellation signal 1033) based on the AIC coefficient 1060. The AIC circuit 1032 may provide the cancellation signal 1033 to the adder 1028. The adder 1028 may generate an output by combining a signal received from the BPF 1078 and the cancellation signal 1033. For example, the adder 1028 may generate the output by subtracting the cancellation signal 1033 from the signal received via the BPF 1078. The system 1000 may enable an AIC circuit to provide a cancellation signal to a first receive antenna based on a feedback signal received by a second receive antenna.

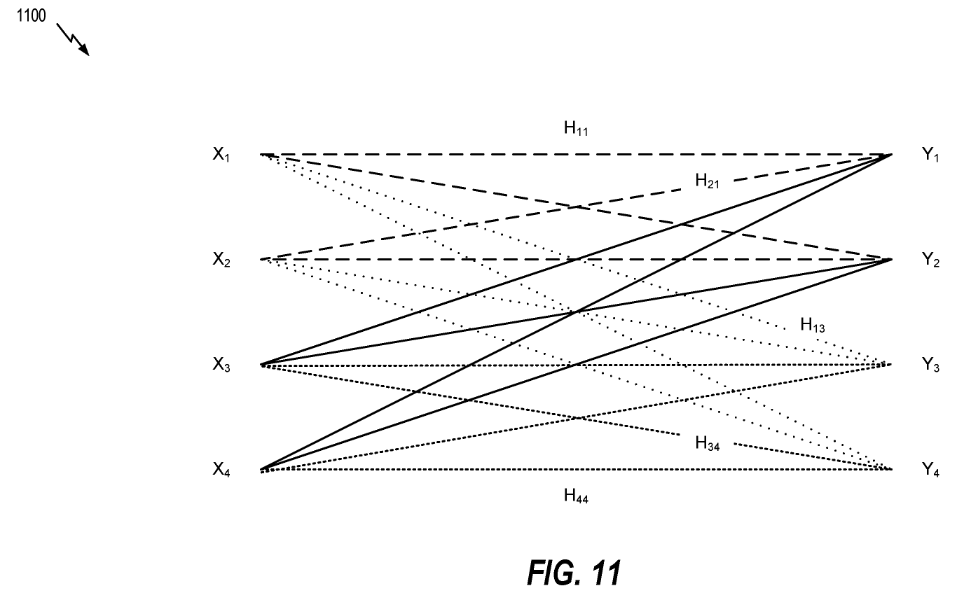

Referring to FIG. 11, a particular illustrative example of an antenna configuration and interference characteristics between antennas is shown and generally designated 1100. One or more antennas of the systems 100-700 and 1000 of FIGS. 1-7 and 10 may be arranged corresponding to the antenna configuration 1100.

The antenna configuration 1100 may include a first set of transmitting antennas (X1-X4). The first set of transmitting antennas may include the TX antenna 170, the TX antenna 172 of FIG. 1, or both. The antenna configuration 1100 may include a second set of receiving antennas (Y1-Y4). The second set of receiving antennas may include the RX antenna 174, the RX antenna 176, or both.

The device 102 may include fewer AIC circuits than would be used to concurrently generate cancellation signals corresponding to each of the first set of transmitting antennas and each of the second set of receiving antennas. For example, the control circuitry 104 of FIG. 1 may determine that a count of AIC circuits is less than a product of a first number of transmit antennas (e.g., the TX antenna 170, the TX antenna 172 of FIG. 1, or both) and a second number of receive antennas (e.g., the RX antenna 174, the RX antenna 176, or both). The control circuitry 104 of FIG. 1 may, in response to determining that the count of AIC circuits is less than the product of the first number of transmit antennas and the second number of receive antennas, determine channel coefficients (e.g., strengths) using a time-share of the AIC circuits. For example, the control circuitry 104 may operate the input switching circuitry 110, the AIC circuitry 130, the feedback switches (e.g., the FB switch 212-218), or a combination thereof, to generate a first subset of the channel coefficients, as described herein. The control circuitry 104 may operate (e.g., reconfigure) the input switching circuitry 110, the AIC circuitry 130, the feedback switches (e.g., the FB switch 212-218), or a combination thereof, to generate a second subset of the channel coefficients, as described herein. For example, the control circuitry 104 of FIG. 1 may operate the input switching circuitry 110 of FIG. 1 to have input switches (e.g., the first input switch 112 and the second input switch 114) select a first subset of the transmitting antennas (e.g., X1 and X2). The control circuitry 104 may operate the AIC circuitry 130 to activate AIC circuits (e.g., the first set of AIC circuits 132 and the second set of AIC circuits 134). The control circuitry 104 may operate feedback switches (e.g., the FB switch 212-218) to select a first subset of the receiving antennas (e.g., Y1 and Y2). The AIC circuitry 130 may determine channel coefficients (e.g., strengths) of signals transmitted by the transmitting antennas (e.g., X1 and X2) based on sequences of pilot symbols, as described with reference to FIG. 9. For example, the AIC circuitry 130 may determine a channel coefficient H11 corresponding to a transmitting antenna X1 and a receiving antenna Y1, a channel coefficient H12 corresponding to the transmitting antenna X1 and a receiving antenna Y2, a channel coefficient H21 corresponding to a transmitting antenna X2 and the receiving antenna Y1, and a channel coefficient H22 corresponding to the transmitting antenna X2 and the receiving antenna Y2.

The control circuitry 104 may operate the feedback switches (e.g., the FB switch 212-218) to select a second subset of the receiving antennas (e.g., Y3 and Y4). The AIC circuitry 130 may determine a channel coefficient H13 corresponding to the transmitting antenna X1 and a receiving antenna Y3, a channel coefficient H14 corresponding to the transmitting antenna X1 and the receiving antenna Y4, a channel coefficient H23 corresponding to the transmitting antenna X2 and the receiving antenna Y3, and the channel coefficient H24 corresponding to the transmitting antenna X2 and the receiving antenna Y4.

The control circuitry 104 of FIG. 1 may operate the input switching circuitry 110 of FIG. 1 to have input switches (e.g., the first input switch 112 and the second input switch 114) select a second subset of the transmitting antennas (e.g., X3 and X4). The control circuitry 104 may operate feedback switches (e.g., the FB switch 212-218) to select the first subset of the receiving antennas (e.g., Y1 and Y2). The AIC circuitry 130 may determine a channel coefficient H31 corresponding to a transmitting antenna X3 and the receiving antenna Y1, a channel coefficient H32 corresponding to the transmitting antenna X3 and the receiving antenna Y2, a channel coefficient H41 corresponding to a transmitting antenna X4 and the receiving antenna Y1, and a channel coefficient H42 corresponding to the transmitting antenna X4 and the receiving antenna Y2.

The control circuitry 104 may operate the feedback switches (e.g., the FB switch 212-218) to select the second subset of the receiving antennas (e.g., Y3 and Y4). The AIC circuitry 130 may determine a channel coefficient H33 corresponding to the transmitting antenna X3 and the receiving antenna Y3, a channel coefficient H34 corresponding to the transmitting antenna X3 and the receiving antenna Y4, a channel coefficient H43 corresponding to the transmitting antenna X4 and the receiving antenna Y3, and the channel coefficient H44 corresponding to the transmitting antenna X4 and the receiving antenna Y4.

The control circuitry 104 may select a subset of the channel coefficients (H11-H44) and may activate AIC circuits corresponding to the selected channel coefficients. For example, the control circuitry 104 may select a first number of higher (or lower) channel coefficients. The first number may correspond to a count of available AIC circuits of the AIC circuitry 130.

The control circuitry 104 may operate the input switching circuitry 110, the AIC circuitry 130, the feedback switches (e.g., the FB switch 212-218), and the output switching circuitry 150 to generate cancellation signals corresponding to the selected channel coefficients. For example, the control circuitry 104 may, in response to determining that the channel coefficient H11 is selected, operate the first input switch 112 to select the transmitting antenna X1 (e.g., the TX antenna 170), operate the FB switch 212 to select the FB input (e.g., the FB input 284) corresponding to the receiving antenna Y1 (e.g., the RX antenna 174), operate the output switch 153 to select the receiving antenna Y1, activate the AIC circuit 232 to generate the first component 233 of the cancellation signal 133, or a combination thereof. The control circuitry 104 may, at various times, determine the channel coefficients to detect changes in channel conditions. The control circuitry 104 may activate the same or distinct AIC circuits in response to a change in the channel coefficients. The control circuitry 104 may thus selectively activate circuitry to generate cancellation signals corresponding to selected channel coefficients.

Referring to FIG. 12, particular illustrative examples of antenna configurations are shown and generally designated 1200. The antenna configurations 1200 include a configuration 1202 and a configuration 1204. One or more antennas of the systems 100-700 and 1000 of FIGS. 1-7 and 10 may be arranged corresponding to the configuration 1202. One or more antennas of the systems 100-700 and 1000 of FIGS. 1-7 and 10 may be arranged corresponding to the configuration 1204.

The configuration 1202 may include a plurality of antennas arranged at substantially the same distance from a receive antenna. For example, the configuration 1202 includes the RX antenna 174 at substantially the same distance from each of the TX antenna 170 (TX1), the TX antenna 172 (TX2), a TX antenna 1270 (TX3), and a TX antenna 1272 (TX4).

Due to the symmetry of the configuration 1202, a single feedback signal may be used to generate an AIC coefficient for each of the TX antennas 170-172, 1270-1272. For example, the coefficient calculator 106 may generate the AIC coefficient 360 corresponding to the first input signal 222 and the feedback signal 283. The coefficient calculator 106 may generate a second AIC coefficient based on the second input signal 224 and the feedback signal 283. The coefficient calculator 106 may generate a third AIC coefficient based on the feedback signal 283 and a third input signal received from the TX antenna 1270. The coefficient calculator 106 may generate a fourth AIC coefficient based on the feedback signal 283 and a fourth input signal received from the TX antenna 1272. The AIC coefficient 360 may be substantially similar to each of the second AIC coefficient, the third AIC coefficient, or the fourth AIC coefficient. The coefficient calculator 106 may be configured to generate a set of AIC coefficients including at least one of the AIC coefficient 360, the second AIC coefficient, the third AIC coefficient, or the fourth AIC coefficient. The set of AIC coefficients may include digital values. For example, at least one of the AIC coefficient 360, the second AIC coefficient, the third AIC coefficient, or the fourth AIC coefficient may correspond to a digital value. The first set of AIC circuits 132 and the second set of AIC circuits 134 may be responsive to the set of AIC coefficients. For example, the AIC 232 may be responsive to the AIC coefficient 360, as described with reference to FIG. 3.

In some implementations, the coefficient calculator 106 may generate the AIC coefficient 360, the second AIC coefficient, the third AIC coefficient, the fourth AIC coefficient, or a combination thereof, during a training stage. The coefficient calculator 106 (or the control circuitry 104) may generate (or update) the coefficient group data 196 to indicate that a first coefficient group includes a first pair having the TX antenna 170 and the RX antenna 174, a second pair having the TX antenna 172 and the RX antenna 174, a third pair having the TX antenna 1270 and the RX antenna 174, and fourth pair having the TX antenna 1272 and the RX antenna 174. The coefficient calculator 106 (or the control circuitry 104) may generate (or update) the coefficient group data 196 in response to determining that the AIC coefficient 360 is the same as (or similar to) the second AIC coefficient, the third AIC coefficient, the fourth AIC coefficient, or a combination thereof.

The control circuitry 104 may activate portions of the AIC circuitry 130 such that the coefficient calculator 106 receives the coefficient input signal 370 from a single AIC circuit (e.g., the AIC circuit 232) and provides the AIC coefficient 360 to multiple AIC circuits. For example, the control circuitry 104 may activate a first AIC circuit corresponding to a single pair of the first coefficient group and may partially activate AIC circuits corresponding to the remaining pairs. For example, the control circuitry 104 may activate the AIC circuit 232. The control circuitry 104 may partially activate the AIC circuit 238, a first AIC circuit coupled to the TX antenna 1270 and the RX antenna 174, and a second AIC circuit coupled to the TX antenna 1272 and the RX antenna 174. Partially activating a particular AIC circuit may include deactivating the second modulator 306 of the particular AIC circuit. For example, the control circuitry 104 may deactivate the second modulator 306 of the AIC circuit 238, the first AIC circuit, the second AIC circuit, or a combination thereof.

The coefficient calculator 106 may generate the AIC coefficient 360 based on the coefficient input signal 370 received from the second modulator 306 of the AIC circuit 232. The coefficient calculator 106 may, in response to determining that the AIC circuit 232, the AIC circuit 238, the first AIC circuit, and the second AIC circuit are associated with the same coefficient group, apply (e.g., provide) the AIC coefficient 360 to the AIC circuit 232, to the AIC circuit 238, to the first AIC circuit, and to the second AIC circuit.

The configuration 1204 may include a plurality of transmitting antennas and a plurality of receiving antennas. For example, the configuration 1204 includes the TX antenna 170, the TX antenna 172, the TX antenna 1270, the TX antenna 1272, the RX antenna 174, the RX antenna 176, an RX antenna 1274, and an RX antenna 1276. An RX antenna may be positioned between each pair of TX antennas. For example, as illustrated in FIG. 12, the TX antenna 170, the TX antenna 172, the TX antenna 1270, and the TX antenna 1272 may be arranged to form a square. The RX antenna 174, the RX antenna 176, the RX antenna 1274, and the RX antenna 1276 may be arranged at mid-points of the sides of the square.

A transmission from a TX antenna may cause the same interference in each of a closer pair of RX antennas and may cause the same interference in each of a further pair of RX antennas. For example, a transmission from the TX antenna 170 may cause the same interference in a signal received by the RX antenna 1276 and a signal received by the RX antenna 174. The same cancellation signal may be applied at the RX antenna 1276 and the RX antenna 174 to cancel the interference of the transmission from the TX antenna 170. The transmission from the TX antenna 170 may cause the same interference in a signal received by the RX antenna 1274 as a signal received by the RX antenna 176. A transmission from the TX antenna 172 may cause the same interference in a signal received by the RX antenna 174 and a signal received by the RX antenna 176. The transmission from the TX antenna 172 may cause the same interference in a signal received by the RX antenna 1276 as a signal received by the RX antenna 1274.

A transmission from the TX antenna 1270 may cause the same interference in a signal received by the RX antenna 176 and a signal received by the RX antenna 1274. The transmission from the TX antenna 1270 may cause the same interference in a signal received by the RX antenna 1276 as a signal received by the RX antenna 174. A transmission from the TX antenna 1272 may cause the same interference in a signal received by the RX antenna 1276 and a signal received by the RX antenna 1274. The transmission from the TX antenna 1272 may cause the same interference in a signal received by the RX antenna 176 as a signal received by the RX antenna 174.

The same (e.g., a first) cancellation signal may be applied to each of the closer pair of RX antennas to reduce (or cancel) the interference of the transmission from the TX antenna and the same (e.g., a second) cancellation signal may be applied to each of the further pair of RX antennas to reduce (or cancel) the interference of the transmission from the TX antenna. For example, a first cancellation signal may be applied at the RX antenna 1276 and to the RX antenna 174 to reduce the interference of the transmission from the TX antenna 170. A second cancellation signal may be applied at the RX antenna 176 and to the RX antenna 1274 to reduce the interference of the transmission from the TX antenna 170.

A first common coefficient may be used to generate a cancellation signal that is applied to an RX antenna to reduce interference from a TX antenna when the RX antenna is closer to the TX antenna. For example, a first coefficient may be used to generate a first cancellation signal that is applied to the RX antenna 174 (and the RX antenna 1276) to reduce interference of a transmission from the TX antenna 170. The first coefficient may also be used to generate a second cancellation signal that is applied to the RX antenna 174 (and the RX antenna 176) to reduce interference of a transmission from the TX antenna 172. The coefficient group data 196 of FIG. 1 may indicate that a first coefficient group includes a pair having the TX antenna 170 and the RX antenna 174, a pair having the TX antenna 170 and the RX antenna 1276, a pair having the TX antenna 172 and the RX antenna 174, a pair having the TX antenna 172 and the RX antenna 176, a pair having the TX antenna 1270 and the RX antenna 176, a pair having the TX antenna 1270 and the RX antenna 1274, a pair having the TX antenna 1272 and the RX antenna 1274, a pair having the TX antenna 1272 and the RX antenna 1276, or a combination thereof.

A second common coefficient may be used to generate a cancellation signal that is applied to an RX antenna to reduce interference from a TX antenna when the RX antenna is further from the TX antenna. For example, a second coefficient may be used to generate a first cancellation signal that is applied to the RX antenna 174 (and the RX antenna 176) to reduce interference of a transmission from the TX antenna 1272. The second coefficient may also be used to generate a second cancellation signal that is applied to the RX antenna 174 (and the RX antenna 1276) to reduce interference of a transmission from the TX antenna 1270. The coefficient group data 196 of FIG. 1 may indicate that a second coefficient group includes a pair having the TX antenna 170 and the RX antenna 176, a pair having the TX antenna 170 and the RX antenna 1274, a pair having the TX antenna 172 and the RX antenna 1274, a pair having the TX antenna 172 and the RX antenna 1276, a pair having the TX antenna 1270 and the RX antenna 174, a pair having the TX antenna 1270 and the RX antenna 1276, a pair having the TX antenna 1272 and the RX antenna 174, a pair having the TX antenna 1272 and the RX antenna 176, or a combination thereof.

The control circuitry 104 may identify pairs of a particular coefficient group that correspond to the same TX antenna. For example, the control circuitry 104 may identify the pair having the TX antenna 170 and the RX antenna 174 and the pair having the TX antenna 170 and the RX antenna 1276 based on the first coefficient group. The control circuitry 104 may determine that the TX antenna 170 causes a similar interference to RX antennas of each of the identified pairs. For example, the control circuitry 104 may determine that the TX antenna 170 causes similar interference to the RX antenna 174 and to the RX antenna 1276. The control circuitry 104 may activate an AIC circuit corresponding to one of the identified pairs to generate a cancellation signal and may apply the same cancellation signal to each cancellation input of the RX antennas of the identified pairs. For example, the control circuitry 104 may activate the AIC circuit 232 to generate the cancellation signal 133. The AIC circuit 232 may provide the cancellation signal 133 to the RX output 184 of the RX antenna 174 to reduce interference from the TX antenna 170. The control circuitry 104 may, in response to determining that the TX antenna 170 causes similar interference to the RX antenna 1276 as to the RX antenna 174, provide the cancellation signal 133 to an RX output of the RX antenna 1276 to reduce interference from the TX antenna 170.

As another example, the control circuitry 104 may identify the pair having the TX antenna 170 and the RX antenna 176 and the pair having the TX antenna 170 and the RX antenna 1274 based on the second coefficient group. The control circuitry 104 may determine that the TX antenna 170 causes similar interference to the RX antenna 176 and to the RX antenna 1274. The control circuitry 104 may activate the AIC circuit 236 to generate the cancellation signal 135. The AIC circuit 236 may provide the cancellation signal 135 to the RX output 186 of the RX antenna 176 to reduce interference from the TX antenna 170. The control circuitry 104 may, in response to determining that the TX antenna 170 causes similar interference to the RX antenna 1274 as to the RX antenna 176, provide the cancellation signal 135 to an RX output of the RX antenna 1274 to reduce interference from the TX antenna 170.

A first coefficient may be used by AIC circuits corresponding to pairs of the first coefficient group and a second coefficient may be used by AIC circuits corresponding to pairs of the second coefficient group. The second modulator 306 of an AIC circuit corresponding to a single pair of a particular coefficient group may provide a coefficient input signal to the coefficient calculator 106. The control circuitry 104 may deactivate the second modulator 306 of AIC circuits corresponding to the remaining pairs of the particular coefficient group. The coefficient calculator 106 may generate an AIC coefficient based on the coefficient input signal and may provide the AIC coefficient to each first modulator 304 of AIC circuits corresponding to the pairs of the particular coefficient group. For example, the second modulator 306 of the AIC circuit 232 corresponding to the pair having the TX antenna 170 and the RX antenna 174 of the first coefficient group may provide the coefficient input signal 370 to the coefficient calculator 106. The control circuitry 104 may deactivate the second modulator 306 of AIC circuits corresponding to the remaining pairs of the first coefficient group. The coefficient calculator 106 may generate the AIC coefficient 360 based on the coefficient input signal 370 and may provide the AIC coefficient 360 to each first modulator 304 of AIC circuits corresponding to the pairs of the first coefficient group.

As another example, the second modulator 306 of the AIC circuit 236 corresponding to the pair having the TX antenna 170 and the RX antenna 176 of the second coefficient group may provide a coefficient input signal to the coefficient calculator 106. The control circuitry 104 may deactivate the second modulator 306 of AIC circuits corresponding to the remaining pairs of the second coefficient group. The coefficient calculator 106 may generate an AIC coefficient based on the coefficient input signal and may provide the AIC coefficient to each first modulator 304 of AIC circuits corresponding to the pairs of the second coefficient group. In a particular aspect, some interference may remain after applying the cancellation signals because a particular coefficient group includes pairs corresponding to similar coefficients that are not identical. The remaining interference may be reduced by applying digital interference cancellation.

The antenna configurations 1200 may thus enable the control circuitry 104 to take advantages of symmetries to generate cancellation signals using fewer circuits. For example, the control circuitry 104 may activate AIC circuits to generate a first number (e.g., 8) of cancellation signals that is less than a product of a count of the transmitting antennas and a count of the receiving antennas. As another example, the control circuitry 104 may deactivate second modulators of some of the AIC circuits and reuse coefficients generated by a subset of the AIC circuits. The device 102 may conserve power by using fewer circuits.

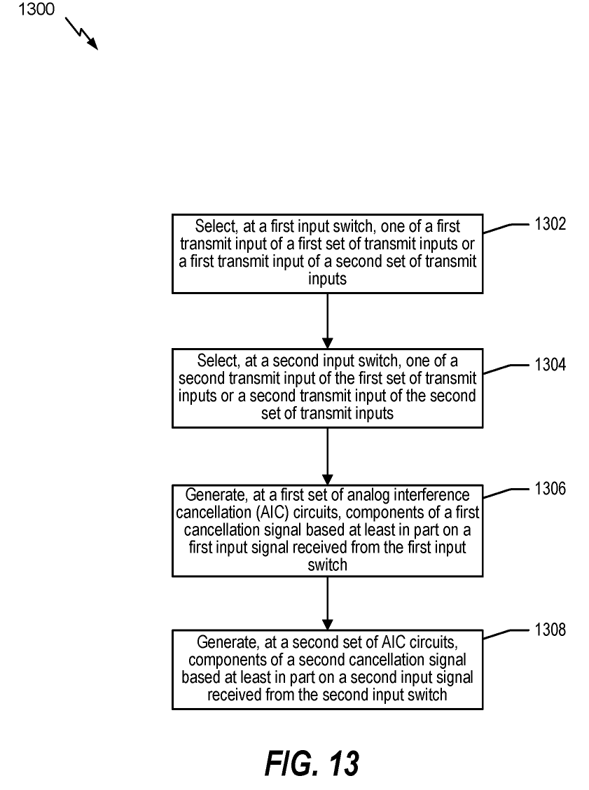

Referring to FIG. 13, a particular aspect of a method of operation is shown and generally designated 1300. In a particular aspect, the method 1300 may be performed by the device 102 of FIG. 1.

The method 1300 includes selecting, at a first input switch, one of a first transmit input of a first set of transmit inputs or a first transmit input of a second set of transmit inputs, at 1302. For example, the first input switch 112 may select the TX input 171 of the first set of transmit inputs 145 (e.g., the TX input 171 and the TX input 173) or the TX input 175 of the second set of transmit inputs 147 (e.g., the TX input 175 and the TX input 177), such as described with reference to FIG. 2.

The method 1300 also includes selecting, at a second input switch, one of a second transmit input of the first set of transmit inputs or a second transmit input of the second set of transmit inputs, at 1304. For example, the second input switch 114 may select the TX input 173 of the first set of transmit inputs 145 (e.g., the TX input 171 and the TX input 173) or the TX input 177 of the second set of transmit inputs 147 (e.g., the TX input 175 and the TX input 177), such as described with reference to FIG. 2.

The method 1300 further includes generating, at a first set of analog interference cancellation (AIC) circuits, components of a first cancellation signal based at least in part on a first input signal received from the first input switch, at 1306. For example, the first set of AIC circuits 132 (e.g., the AIC circuit 232 and the AIC circuit 238) may generate components (e.g., the first component 233 and the second component 235) of the cancellation signal 133 based at least in part on the first input signal 222 received from the first input switch 112, as described with reference to FIG. 2.

The method 1300 also includes generating, at a second set of AIC circuits, components of a second cancellation signal based at least in part on a second input signal received from the second input switch, at 1308. For example, the second set of AIC circuits 134 (e.g., the AIC circuit 234 and the AIC circuit 236) may generate components (e.g., the first component 237 and the second component 239) of the cancellation signal 135 based at least in part on the second input signal 224 received from the second input switch 114, as described with reference to FIG. 2.

The method 1300 may enable an input switch to select one of a first set of transmit inputs or a second set of transmit inputs and an AIC circuit to generate a component of a cancellation signal based on an input signal received from the input switch. The same AIC circuits may thus be used to generate cancellation signals when first antennas corresponding to the first set of transmit inputs are transmitting as when second antennas corresponding to the second set of transmit inputs are transmitting by having input switches switch from the first set of transmit inputs to the second set of transmit inputs.

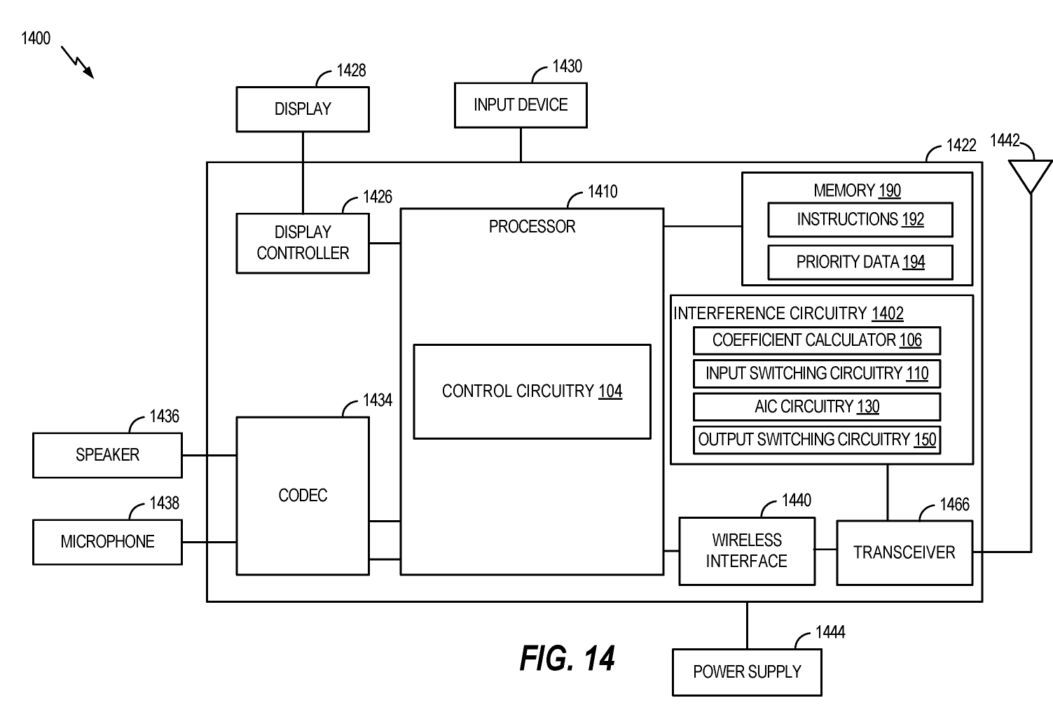

Referring to FIG. 14, a particular illustrative aspect of a wireless communication device is depicted and generally designated 1400. The device 1400 includes a processor 1410, such as a digital signal processor, coupled to the memory 190. In an illustrative aspect, the device 1400, or components thereof, may correspond to the device 102 of FIG. 1. The processor 1410 may include the control circuitry 104 of FIG. 1.

The processor 1410 may be configured to execute software (e.g., a program of the one or more instructions 192) stored in the memory 190. Additionally or alternatively, the processor 1410 may be configured to implement one or more instructions stored in a memory of a wireless interface 1440 (e.g., an Institute of Electrical and Electronics Engineers (IEEE) 802.11 compliant interface). For example, the wireless interface 1440 may be configured to operate in accordance with one or more wireless communication standards, including one or more IEEE 802.11 standards and one or more NAN standards. In a particular aspect, the processor 1410 may be configured to perform one or more operations or methods described with reference to FIGS. 1-13. For example, the processor 1410 may be configured to operate the input switching circuitry 110, the AIC circuitry 130, the output switching circuitry 150, the coefficient calculator 106, or a combination thereof. The memory 190 may be configured to store the priority data 194.

The wireless interface 1440 may be coupled to the processor 1410 and to a plurality of antennas 1442. For example, the wireless interface 1440 may be coupled to the antennas 1442 via a transceiver 1466, such that wireless data may be received via the antennas 1442 and may be provided to the processor 1410. The antennas 1442 may include the TX antennas 170-172, the RX antennas 174-176 of FIG. 1, the RX antennas 1074-1076 of FIG. 10, the TX antennas 1270-1272, the RX antennas 1274-1276 of FIG. 12, or a combination thereof. The transceiver 1466 may be coupled to interference circuitry 1402. The interference circuitry 1402 may include the coefficient calculator 106, the input switching circuitry 110, the AIC circuitry 130, the output switching circuitry 150, or a combination thereof.

A coder/decoder (CODEC) 1434 can also be coupled to the processor 1410. A speaker 1436 and a microphone 1438 can be coupled to the CODEC 1434. A display controller 1426 can be coupled to the processor 1410 and to a display device 1428. In a particular aspect, the processor 1410, the display controller 1426, the memory 190, the CODEC 1434, and the wireless interface 1440 are included in a system-in-package or system-on-chip device 1422. In a particular aspect, an input device 1430 and a power supply 1444 are coupled to the system-on-chip device 1422. Moreover, in a particular aspect, as illustrated in FIG. 14, the display device 1428, the input device 1430, the speaker 1436, the microphone 1438, the antennas 1442, and the power supply 1444 are external to the system-on-chip device 1422. However, each of the display device 1428, the input device 1430, the speaker 1436, the microphone 1438, the antennas 1442, and the power supply 1444 can be coupled to one or more components of the system-on-chip device 1422, such as one or more interfaces or controllers. In a particular aspect, the device 1400 may include at least one of a mobile phone, a communication device, a computer, a music player, a video player, an entertainment unit, a navigation device, a personal digital assistant (PDA), a decoder, or a set top box.

In conjunction with the described aspects, an apparatus includes first means for selecting one of a first transmit input of a first set of transmit inputs or a first transmit input of a second set of transmit inputs. For example, the first means for selecting may include the first input switch 112, the input switching circuitry 110 of FIG. 1, one or more other devices, circuits, or modules configured to select one of a first transmit input of a first set of transmit inputs or a first transmit input of a second set of transmit inputs, or a combination thereof.

The apparatus also includes second means for selecting one of a second transmit input of the first set of transmit inputs or a second transmit input of the second set of transmit inputs. For example, the second means for selecting may include the second input switch 114, the input switching circuitry 110 of FIG. 1, one or more other devices, circuits, or modules configured to select one of a second transmit input of the first set of transmit inputs or a second transmit input of the second set of transmit inputs, or a combination thereof.

The apparatus further includes first means for generating components of a first cancellation signal. For example, the first means for generating may include the first set of AIC circuits 132, the AIC circuitry 130 of FIG. 1, the AIC circuit 232 of FIGS. 2-7, the AIC circuit 238 of FIG. 2, one or more other devices, circuits, or modules configured to generate components of a first cancellation signal, or a combination thereof.

The apparatus also includes second means for generating components of a second cancellation signal. For example, the second means for generating may include the second set of AIC circuits 134, the AIC circuitry 130 of FIG. 1, the AIC circuit 234, the AIC circuit 236 of FIG. 2, one or more other devices, circuits, or modules configured to generate components of a second cancellation signal, or a combination thereof.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A multiple input and multiple output device comprising:
a first input switch configured to select one of a first transmit input of a first set of transmit inputs or a first transmit input of a second set of transmit inputs;
a second input switch configured to select one of a second transmit input of the first set of transmit inputs or a second transmit input of the second set of transmit inputs;
a first set of analog interference cancellation (AIC) circuits coupled to the first input switch and to the second input switch, the first set of AIC circuits configured to output components of a first cancellation signal; and
a second set of AIC circuits coupled to the first input switch and to the second input switch, the second set of AIC circuits configured to output components of a second cancellation signal.

2. The device of claim 1, further comprising:
a first output switch including a first cancellation input that is configured to receive the first cancellation signal from the first set of AIC circuits; and
a second output switch including a second cancellation input that is configured to receive the second cancellation signal from the second set of AIC circuits.

3. The device of claim 1, further comprising:
a first output switch including a first cancellation input and configured to select one of a first receive output of a first set of receive outputs or a first receive output of a second set of receive outputs; and
a second output switch including a second cancellation input and configured to select one of a second receive output of the first set of receive outputs or a second receive output of the second set of receive outputs.

4. The device of claim 1, further comprising:
a first set of feedback switches coupled to the first set of AIC circuits and configured to select one of a first feedback input of a first set of feedback inputs or a first feedback input of a second set of feedback inputs; and
a second set of feedback switches coupled to the second set of AIC circuits and configured to select one of a second feedback input of the first set of feedback inputs or a second feedback input of the second set of feedback inputs.

5. The device of claim 1, further comprising a coefficient calculator configured to generate a set of AIC coefficients, wherein the first set of AIC circuits and the second set of AIC circuits are responsive to the set of AIC coefficients, and wherein the set of AIC coefficients comprises digital values.

6. The device of claim 1, wherein at least one AIC circuit includes:
a first modulator having a first input coupled to the first input switch, a second input coupled to a coefficient calculator, and an output configured to generate a component of the first cancellation signal; and
a second modulator coupled to an input of the coefficient calculator and configured to generate a coefficient input signal responsive to a first input signal and a first feedback signal, the first input signal received from the first input switch,
wherein the first feedback signal includes a baseband signal or a radio frequency signal.

7. A method comprising:
selecting, at a first input switch, one of a first transmit input of a first set of transmit inputs or a first transmit input of a second set of transmit inputs;
selecting, at a second input switch, one of a second transmit input of the first set of transmit inputs or a second transmit input of the second set of transmit inputs;
generating, at a first set of analog interference cancellation (AIC) circuits, components of a first cancellation signal based at least in part on a first input signal received from the first input switch; and
generating, at a second set of AIC circuits, components of a second cancellation signal based at least in part on a second input signal received from the second input switch.

8. The method of claim 7, further comprising:
determining a first AIC coefficient at a first AIC circuit of the first set of AIC circuits, wherein a first component of the first cancellation signal is generated, at the first AIC circuit, based on the first AIC coefficient; and
applying the first AIC coefficient to a second AIC circuit in response to determining that the first AIC circuit and the second AIC circuit are associated with a same coefficient group based on coefficient group data.

9. The method of claim 7, further comprising:
providing the first cancellation signal from the first set of AIC circuits to a first cancellation input, wherein a first component of the first cancellation signal is output from a first AIC circuit of the first set of AIC circuits to the first cancellation input;
determining, based on coefficient group data, that a first transmit antenna associated with the first input switch interferes with a first receive antenna associated with the first cancellation input and with a second receive antenna associated with a second cancellation input; and
in response to determining that the first transmit antenna interferes with the first receive antenna and the second receive antenna, providing the first component of the first cancellation signal to the second cancellation input as a second component of the second cancellation signal.

10. The method of claim 7, further comprising:
determining, based on priority data, a relative priority of two or more of a first channel, a second channel, a third channel, or a fourth channel,
wherein the first input switch is associated with a transmission on the first channel;
wherein the second input switch is associated with a transmission on the second channel;
wherein the first cancellation signal is associated with a signal reception on the third channel; and
wherein the second cancellation signal is associated with a signal reception on the fourth channel; and
selectively deactivating at least one AIC circuit corresponding to a lowest relative priority.

11. The method of claim 7, further comprising:
determining a first strength of the first input signal based on a first sequence of pilot symbols, wherein the first input signal includes the first sequence of pilot symbols; and
determine a first number of taps at least partially based on the first strength,
wherein the first cancellation signal is based on the first number of taps,
wherein the first number of taps is further based on a second strength of the second input signal,
wherein the second input signal includes a second sequence of pilot symbols, and
wherein the second strength of the second input signal is based on the second sequence of pilot symbols.

12. The method of claim 7, further comprising:
in response to determining, at a first time, that a difference between the first time and a first update time is greater than a first duration indicated by a threshold, generating a second AIC coefficient based at least in part on the first input signal, wherein the first update time corresponds to generation of a first AIC coefficient at a first AIC circuit;
in response to determining that the first AIC coefficient is the same as the second AIC coefficient, updating the threshold to indicate a greater duration than the first duration; and
in response to determining that the first AIC coefficient is distinct from the second AIC coefficient, updating the threshold to indicate a lower duration than the first duration.

13. The method of claim 7, further comprising, in response to detecting a change in a multiple-in multiple-out (MIMO) configuration of a device that includes the first set of AIC circuits and the second set of AIC circuits, updating a first AIC coefficient based at least in part on the first input signal, wherein a first component of the first cancellation signal is based on the first AIC coefficient.

14. The method of claim 7, further comprising, in response to determining that a feedback signal fails to satisfy a criterion, updating a first AIC coefficient based on the first input signal and the feedback signal, wherein a first component of the first cancellation signal is based on the first AIC coefficient.

15. The method of claim 7, further comprising:
receiving, at a first AIC circuit, a feedback signal from a first receive antenna;
generating a first component of a cancellation signal based on the feedback signal; and
providing the first component of the cancellation signal to a second receive antenna.

16. The method of claim 7, further comprising:
determining a channel configuration associated with a first transmit antenna coupled to the first input switch and a first receive antenna coupled to a first cancellation input;
in response to determining that channel usage data includes the channel configuration, deactivating at least one AIC circuit based on the channel usage data; and
in response to determining that the channel usage data does not include the channel configuration, deactivating one or more AIC circuits based on a feedback signal corresponding to the first receive antenna.

17. The method of claim 7, further comprising, in response to determining that a count of AIC circuits is less than a product of a first number of transmit antennas and a second number of receive antennas:
determining channel coefficients using a time-share of AIC circuits;
selecting one or more sets of AIC circuits based on the channel coefficients; and
applying cancellation based on the selected one or more sets of AIC circuits.

18. The method of claim 7, further comprising:
determining strengths of coupling channels based on input signals received from the transmit antennas and feedback signals corresponding to the receive antennas; and
in response to determining that a first strength of a first coupling channel is greater than a threshold, generating the first cancellation signal based on multiple tapping, wherein the first coupling channel is associated with a first transmit antenna coupled to the first input switch and a first receive antenna of the receive antennas.

19. A computer-readable storage device storing instructions that, when executed by a processor, cause the processor to perform operations comprising:
operating a first input switch to select one of a first transmit input of a first set of transmit inputs or a first transmit input of a second set of transmit inputs;
operating a second input switch to select one of a second transmit input of the first set of transmit inputs or a second transmit input of the second set of transmit inputs;
operating a first set of analog interference cancellation (AIC) circuits to output components of a first cancellation signal to a first cancellation input, the first set of AIC circuits coupled to the first input switch and to the second input switch; and
operating a second set of AIC circuits to output components of a second cancellation signal to a second cancellation input, the second set of AIC circuits coupled to the first input switch and to the second input switch.

20. The computer-readable storage device of claim 19, wherein operating the first input switch includes providing an input to the first input switch, wherein the first input switch selects the first transmit input of the first set of transmit inputs when the input has a first value, and wherein the first input switch selects the first transmit input of the second set of transmit inputs when the input has a second value.
